(19) United States
(12) Patent Application Publication
(10) Pub. No.: US 2011/0039562 A1
(43) Pub. Date: Feb. 17, 2011

(54) SESSION-SPECIFIC SIGNALING FOR MULTIPLE ACCESS NETWORKS OVER A SINGLE ACCESS NETWORK

(75) Inventors: Srinivasan Balasubramanian, San Diego, CA (US); George Cherian, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/700,567

(22) Filed: Feb. 4, 2010

Related U.S. Application Data
(60) Provisional application No. 61/150,163, filed on Feb. 5, 2009.
(60) Provisional application No. 61/150,222, filed on Feb. 5, 2009.

(51) Int. Cl. H04W 36/00

(52) U.S. Cl. 455/436

(57) ABSTRACT

Providing for call-specific signaling for call-setup on multiple wireless communication systems via a single wireless access network is described herein. By way of example, a communication context for a mobile device can be established on a first radio access network (RAN). Additionally, call-specific signaling for a wireless session to be conducted by the mobile device over a second RAN can be conducted over the first RAN. Such signaling can be done, for instance, in preparation for an application or wireless session not supported by the first RAN. In addition, upon identifying an invitation for such an application or wireless session involving the mobile device, the mobile device can be switched to the second RAN, while session bindings on the first RAN can be maintained, ported to the second RAN, or terminated. Accordingly, the subject disclosure can reduce signaling complexity while integrating services of diverse deployments of wireless networks.

### CLAIM OF PRIORITY UNDER 35 U.S.C §119

The present application for patent claims priority to Provisional Patent Application Ser. No. 61/150,163 entitled “VOIP FALLBACK TO EHRPD FROM LTE” filed Feb. 5, 2009 and assigned to the assignee hereof, and to Provisional Patent Application Ser. No. 61/150,222 entitled “VOIP FALLBACK TO EHRPD FROM LTE” filed Feb. 5, 2009 and assigned to the assignee hereof, each of which are hereby expressly incorporated by reference herein.

### BACKGROUND

1. Field

The following description relates generally to wireless communications, and more particularly to facilitating measurement and reporting of radio coverage information based on geographic location of a mobile device.

2. Background

Wireless communication systems are widely deployed to provide various types of communication content, such as voice content, data content, and so on. Typical wireless communication systems can be multiple-access systems capable of supporting communication with multiple users by sharing available system resources (e.g., bandwidth, transmit power, . . . ). Examples of such multiple-access systems can include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), or multi-carrier wireless specifications such as evolution data optimized (EV-DO), one or more revisions thereof, etc.

Generally, wireless multiple-access communication systems can simultaneously support communication for multiple mobile devices. Each mobile device can communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations can be established via single-input single-output (SISO) systems, multiple-input single-output (MISO) systems, multiple-input multiple-output (MIMO) systems, and so forth.

Moreover, wireless communication technology has diversified in recent years, resulting in various types of wireless communication systems. In some cases, these systems exist in overlapping geographic regions, typically providing wireless communication services to respective groups of mobile devices that are configured for respective communication systems. For instance, one wireless system might employ a carrier frequency of 900 megahertz frequency band, whereas another wireless system might use a 2.1 gigahertz frequency band. Furthermore, some communication systems utilize frequency division multiple access (FDMA) for mobile access, others utilize time division multiple access (TDMA) for mobile access, and still others employ code division multiple access (CDMA) for mobile access, and so on. Typically, so long as different radio access networks (RANs) employ suitably orthogonal wireless signals (e.g., different carrier frequencies or frequency channels, different access mechanisms, or the like), interference among different systems in a geographic area can be mitigated or avoided.

Because multiple types of wireless communication systems are commonly available, modern access terminal (AT) devices are often configured to communicate with multiple wireless systems. These types of ATs, which are configured to communicate with multiple wireless systems, are classified as multi-mode devices. As one example, many modern smartphones are adapted to utilize cellular wireless communication as well as WiFi wireless communication. The IPhone® and Blackberry Curve™ are two examples of cell phones that can typically employ a cellular network as well as a WiFi network for wireless communication. Other mobile devices are configured to employ different combinations of multiple cellular networks, such as FDMA systems and CDMA systems. As compatibility with multiple wireless networks becomes more common and more popular, optimizing diverse services of different networks becomes important to provide seamless services for multi-mode mobile devices.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the subject disclosure in a simplified form as a prelude to the more detailed description that is presented later.

The subject disclosure provides for mediation between wireless communication systems to provide services of respective systems to mobile devices. In some aspects, a network can establish a communication session for a mobile device over a first radio access network (RAN), and implement session or application specific signaling over the first RAN to setup a call over a second RAN. In at least one aspect, the first RAN could be a preferred RAN for the mobile device, in terms of supporting a particular type of application or data session, or in subscription-based benefits, or the like. The second RAN could be preferred for a particular type of call, such as call having a specific quality of service (QoS) requirement, or can support a type or level of service particular to an operator or original equipment manufacturer (OEM) of the second RAN.

In further aspects, network entities can analyze attributes of a call involving the mobile device, and arbitrate among a plurality of RANs based on respective capabilities of the RANs or attributes of the call. If the mobile device has an active link with a first RAN that does not support, or does not provide a suitable level of support for the call, the mobile device can switch to a second RAN that can support the call, or provide the level of support. In some aspects, the mobile device can initiate switching to the second RAN. In other aspects, the network can send a page to the mobile device indicating the attributes of the call, as an instruction to switch to the second RAN. In particular aspects, the page can be sent over the active link with the first RAN. In other aspects, the page can be sent over an idle link with the second RAN.

The subject disclosure enables the network to dynamically provide services for the mobile device that can be maintained by one RAN but not another. Additionally, the subject disclosure enables the network and mobile device to switch between RANs and take advantage of diverse services supported by the respective RANs. For instance, a high throughput data session can be provided to the mobile device over a high performance RAN, and a data session having a specific QoS can be provide to the mobile device over another RAN that supports the specific QoS data session.

In particular aspects of the subject disclosure, provided is a method of wireless communication. The method can comprise instructing a wireless core network gateway to provide wireless communication service to a mobile device via a first radio access network (a first RAN. Additionally, the method can comprise instructing the wireless core network gateway to establish session or application specific signaling at least in part over the first RAN for a wireless communication to be conducted over a second RAN.

In other aspects of the subject disclosure, an apparatus configured for wireless communication is provided. The apparatus can comprise a communication interface that facilitates electronic communication with a first radio access network (a first RAN) and with a second RAN. Further, the apparatus can comprise memory for storing instructions configured to provide call-specific signaling for the second RAN over the first RAN. The apparatus can also comprise a data processor configured to execute modules that implement the call-specific signaling. Particularly, the modules can comprise a context module that establishes an electronic communication session for an access terminal (AT) over the first RAN and an arbitration module that analyzes call invitations involving the AT. Moreover, the apparatus can comprise a switching module that causes the context module to establish, at least in part via the first RAN, a second communication session for the AT on the second RAN for a wireless communication involving the AT that is not supported by the first RAN.

According to further aspects, disclosed is an apparatus of wireless communication. The apparatus can comprise means for employing a network gateway for establishing an electronic communication session for an access terminal (AT) over a first radio access network (a first RAN). Moreover, the apparatus can comprise means for employing a processor for analyzing wireless communication invites involving the AT. Further, the apparatus can also comprise means for employing the network gateway to conduct call-specific signaling for the AT over the first RAN to facilitate a wireless communication on a second radio access network that is not supported by the first RAN.

In still other aspects, provided is at least one processor configured for wireless communication. The processor can comprise a module that establishes an electronic communication session for an access terminal (AT) over a first radio access network (a first RAN). The processor can further comprise a module that analyzes wireless communication invites involving the AT. In addition, the processor can also comprise a module that conducts call-specific signaling for the AT over the first RAN to facilitate a wireless communication on a second radio access network that is not supported by the first RAN.

According to a particular aspect, the subject disclosure provides a computer program product comprising a computer-readable medium. The computer-readable medium can comprise code for causing a computer to establish an electronic communication session for an access terminal (AT) over a first radio access network (a first RAN). In addition, the computer-readable medium can comprise code for causing the computer to analyze wireless communication invites involving the AT. Furthermore, the computer-readable medium can comprise code for causing the computer to conduct call-specific signaling for the AT over the first RAN to facilitate a wireless communication on a second radio access network that is not supported by the first RAN.

In addition to the foregoing, the subject disclosure provides a method of wireless communication. The method can comprise employing a wireless transceiver to receive wireless signals from a plurality of radio access networks (a plurality of RANs). Additionally, the method can comprise employing a data processor to analyze characteristics of the wireless signals and select a preferred radio access network (a preferred RAN) from the plurality of RANs. Moreover, the method can also comprise employing the wireless transceiver to initiate or receive an application or session over the preferred RAN, and to activate a link with a second RAN of the plurality of RANs that supports the application or session.

In additional aspects, provided is an apparatus for wireless communication. The apparatus can comprise a communication interface that is configured to employ a wireless transceiver to communicatively couple the apparatus with a plurality of radio access networks (a plurality of RANs). The apparatus can additionally comprise memory for storing instructions configured for selecting different ones of the plurality of RANs based at least on attributes of a wireless communication. Further, the apparatus can comprise a data processor that executes modules to implement the selecting. Specifically, the modules can comprise a network statistics module that references characteristics of one or more of the plurality of RANs based at least on attributes of an anticipated wireless session. In addition, the modules can comprise a swapping module that dynamically switches from a preferred RAN having a first set of capabilities to a second RAN having a second set of capabilities, if a wireless session is initiated at or received by the apparatus, and if the second set of capabilities provide preferable service or cost for the wireless session over the first set of capabilities.

In other aspects, disclosed is an apparatus for wireless communication. The apparatus can comprise means for employing a wireless transceiver to receive wireless signals from a plurality of radio access networks (a plurality of RANs). Furthermore, the apparatus can comprise means for employing a data processor to analyze characteristics of the wireless signals and select a preferred radio access network (a preferred RAN) from the plurality of RANs. Moreover, the apparatus can also comprise means for employing the wireless transceiver to initiate or receive an application or session over the preferred RAN, and activate a link with a second RAN of the plurality of RANs that supports the application or session.

In one or more other aspects, provided is at least one processor configured for wireless communication. The processor(s) can comprise a module that receives wireless signals from a plurality of radio access networks (a plurality of RANs). The processor(s) can further comprise a module that analyzes characteristics of the wireless signals and selects a preferred radio access network (a preferred RAN) from the plurality of RANs. Further, the processor(s) can comprise a module that initiates or receives an application or session over the preferred RAN, and activates a link with a second RAN of the plurality of RANs that supports the application or session.

In at least one aspect, the subject disclosure provides a computer program product comprising a computer-readable medium. The computer-readable medium can comprise code for causing a computer to receive wireless signals from a plurality of radio access networks (a plurality of RANs). Additionally, the computer-readable medium can comprise code for causing the computer to analyze characteristics of the wireless signals and select a preferred radio access network (a preferred RAN) from the plurality of RANs. Further, the computer-readable medium can comprise code for causing the computer to initiate or receive an application or session over the preferred RAN, and activates a link with a second RAN of the plurality of RANs that supports the application or session.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a block diagram of an example system that arbitrates between radio access networks for multi-mode devices according to disclosed aspects.

FIG. 2 illustrates a block diagram of an example system for inter-operability between multiple wireless networks according to further aspects.

FIG. 3 depicts a block diagram of an example wireless communication for arbitrating between wireless radio access networks.

FIG. 4 depicts a diagram of an example network control flow that provides network arbitration for quality control according to additional aspects.

FIG. 5 illustrates a diagram of a sample network control flow that provides network arbitration for uncoupled radio access networks.

FIG. 6 depicts a diagram of a sample network control flow that provides mobile-assisted swapping between radio access networks according to other aspects.

FIG. 7 depicts a block diagram of an example mobile device configured to switch between radio access networks according to at least one aspect.

FIG. 8 illustrates a flowchart of a sample methodology for providing network arbitration between multiple radio access networks.

FIG. 9 depicts a flowchart of a sample methodology for falling back to a high quality radio access network to support a high quality of service session.

FIG. 10 illustrates a flowchart of an example methodology for swapping between radio access networks for network arbitration according to other aspects.

FIG. 11 depicts a flowchart of a sample methodology for providing network arbitration for wireless communication in still other aspects.

FIG. 12 illustrates a block diagram of a sample system that facilitates network arbitration for network management according to one or more aspects.

FIG. 13 depicts a block diagram of a sample system that provides mobile assisted network arbitration according to other aspects.

FIG. 14 illustrates a block diagram of a sample wireless communications apparatus employed in implementing various aspects of the subject disclosure.

FIG. 15 depicts a block diagram of an example cellular environment for wireless communications according to further aspects.

FIG. 16 illustrates a block diagram of an example wireless signaling environment for wireless communications.

### DETAILED DESCRIPTION

Various aspects are now described with reference to the drawings, wherein like reference numerals are used to refer to like elements throughout. In the following description, for purposes of explanation, numerous specific details are set forth in order to provide a thorough understanding of one or more aspects. It can be evident, however, that such aspect(s) can be practiced without these specific details. In other instances, well-known structures and devices are shown in block diagram form in order to facilitate describing one or more aspects.

In addition, various aspects of the disclosure are described below. It should be apparent that the teaching herein can be embodied in a wide variety of forms and that any specific structure and/or function disclosed herein is merely representative. Based on the teachings herein one skilled in the art should appreciate that an aspect disclosed herein can be implemented independently of any other aspects and that two or more of these aspects can be combined in various ways. For example, an apparatus can be implemented and/or a method practiced using any number of the aspects set forth herein. In addition, an apparatus can be implemented and/or a method practiced using other structure and/or functionality in addition to or other than one or more of the aspects set forth herein. As an example, many of the methods, devices, systems and apparatuses described herein are described in the context of providing network arbitration to support high quality wireless communication. One skilled in the art should appreciate that similar techniques could apply to other communication environments.

Wireless communication systems achieve electronic communication between remotely located wireless nodes through local infrastructure deployments and central networks that communicatively couple local infrastructure (e.g., a base station). In general, the local infrastructure can utilize various principles to exchange wireless information with these nodes. But each case depends on establishing a wireless link between a transmitter of the wireless node and a receiver of the local infrastructure or base station, and vice versa. For multiple access systems, the wireless link involves a transmitter-receiver pair coordinating a set of orthogonal wireless resources (e.g., frequency subband, time subslot, code-spread factor, and so on), employed by the wireless node and local infrastructure. By transmitting or decoding signals only on the set of orthogonal wireless resources, data transmitted on one wireless link (set of resources employed by a transmitter-receiver pair) can be distinguished from data transmitted on other wireless links (sets of resources employed by other transmitter-receiver pairs). Furthermore, each transmitter-receiver pair employing a distinct wireless link forms a distinct spatial channel, also referred to as a wireless channel, or signal dimension.

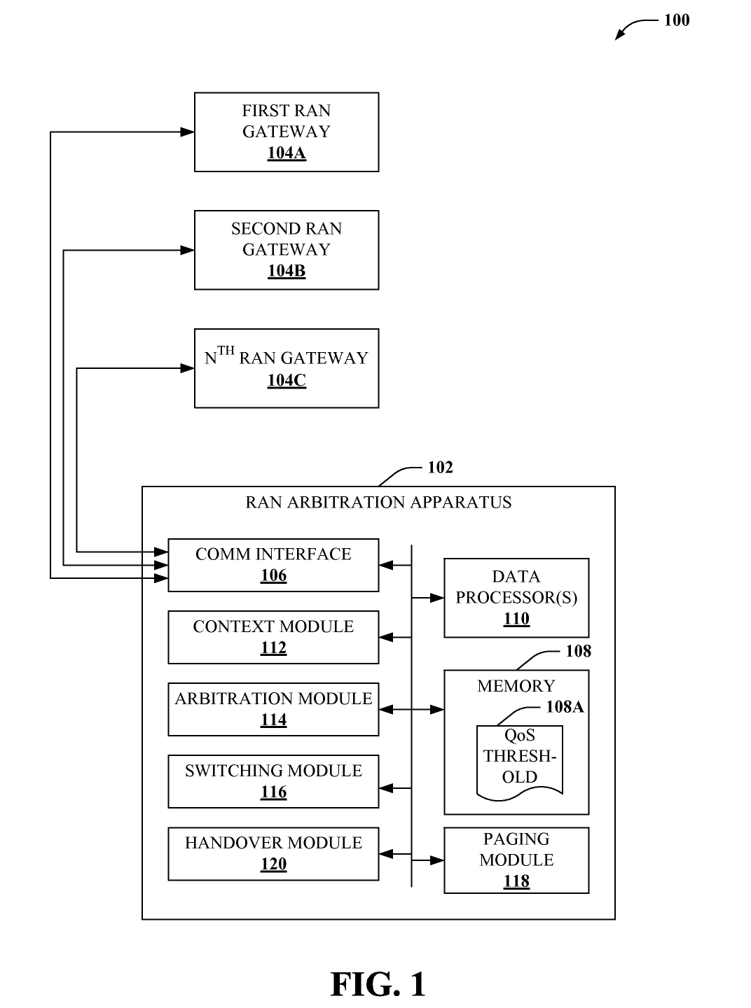

FIG. 1 illustrates a block diagram of an example system 100 for arbitrating among a plurality of radio access networks (a plurality of RANs) according to aspects of the subject disclosure. System 100 can be deployed in conjunction with a wireless core network, in some aspects of the subject disclosure. In other aspects, system 100 can be deployed in conjunction with an operator's wireless network.

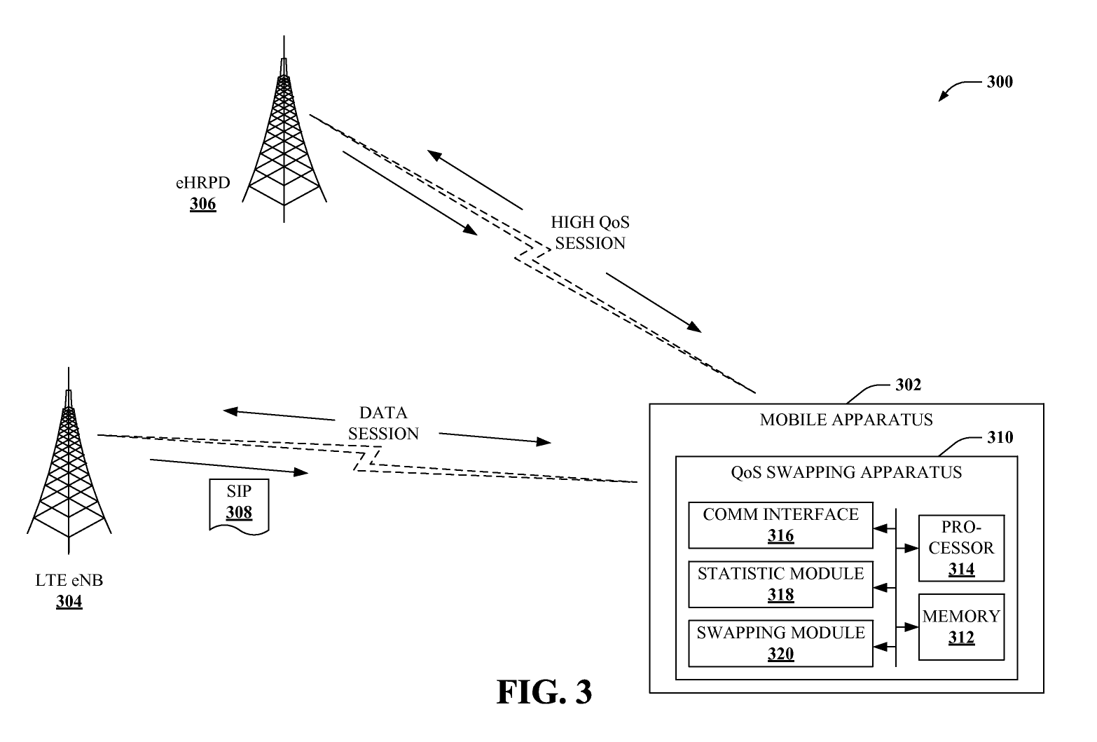

System 100 comprises a RAN arbitration apparatus 102 communicatively coupled with a plurality of RANs. As depicted, RAN arbitration apparatus 102 can be coupled with a first RAN gateway 104A, a second RAN gateway 104B, up through an N^{th} RAN gateway 104C (collectively referred to herein as RAN gateways 104A-104C), where N is a positive integer greater than one. RAN arbitration apparatus 102 is configured to switch active association of a mobile communication device (not depicted, but see FIG. 3, infra) among a plurality of RANs (associated with respective RAN gateways 104A-104C) based on requirements or attributes of calls involving the mobile communication device, and call supporting characteristics of respective RAN gateways 104A-104C. As one particular example of operation, RAN arbitration apparatus 102 can be configured to switch the active association from a first RAN (e.g., a RAN having a first set of capabilities) to a second RAN (e.g., a RAN having a second set of capabilities), if a call requiring a specific quality of service (QoS) or specific level of QoS (e.g., greater than best effort QoS) is initiated for the mobile communication device.

RAN arbitration apparatus 102 can be deployed at various locations within a wireless communication network. As one example of deployment, system 100 can be installed as part of a packet data network (PDN) gateway that is communicatively coupled to RAN gateways 104A-104C. As another example of deployment, system 100 can be installed as part of a wireless operator's network, that is communicatively coupled to the above PDN gateway, or that is directly coupled to RAN gateways 104A-104C. In yet another example deployment, RAN arbitration apparatus 102 could be deployed as part of a wireless core network entity. It should be appreciated, however, that the subject disclosure is not limited to the example locations of RAN arbitration apparatus 102 specifically listed, as other suitable deployments can be implemented and are considered within the scope of the subject disclosure.

The following description provides one example of RAN arbitration apparatus 102 in operation. To communicate with various network components, RAN arbitration apparatus 102 can comprise a communication interface 106 that facilitates electronic communication with a plurality of RANs, including a first RAN and with a second RAN via respective RAN gateways, 104A, 104B. Utilizing communication interface 106, RAN arbitration apparatus 102 can monitor traffic originating from or targeted to a mobile device served by the first RAN or the second RAN. In addition, RAN arbitration apparatus 102 can comprise memory 108 for storing instructions configured to provide call-specific signaling for the second RAN over the first RAN. The call-specific signaling can facilitate enhanced arbitration between the first and second RAN. In at least one particular aspect, arbitration between the first RAN and the second RAN can be based at least in part on a characteristic of a wireless communication, such as optimal performance (e.g., throughput, data rate, etc.), QoS requirements, or subscription-based requirements (e.g., low cost or fixed cost service). In additional aspects, arbitration between the first RAN and the second RAN can be based on operator or original equipment manufacturer (OEM) supported applications, services, or subscription-based characteristics offered via the respective RANs. Further to the above, RAN arbitration apparatus 102 can comprise one or more data processors 110 configured to execute modules that implement the call-specific signaling between the first RAN and the second RAN.

In one specific aspect of the subject disclosure, modules employed by RAN arbitration apparatus 102 for the call-specific signaling and traffic arbitration among different RAN networks associated with RAN gateways 104A-104C can comprise the following: a context module 112 that establishes an electronic communication session for an access terminal (AT) over the first RAN, an arbitration module 114 that analyzes call invitations involving the AT, and a switching module 116 that causes the context module to establish, at least in part via the first RAN, a second communication session for the AT on the second RAN, for a wireless communication involving the AT that is not supported by the first RAN. As utilized herein, the wireless communication is considered not supported if the first RAN does not provide a specific QoS utilized for the wireless communication, does not meet a throughput or data rate of another of the plurality of RANs for the wireless communication, or does not meet a subscription cost or pricing level of another of the plurality of RANs, or the like, or a suitable combination thereof. As one particular example, switching module 116 causes context module 112 to initiate call-specific signaling for a wireless communication involving a specific QoS on the second RAN, if arbitration module 114 identifies a call involving the AT that exceeds QoS capabilities of the first RAN.

QoS requirements of the traffic involving the AT can be stored in memory 108 in a QoS threshold file 108A. Particularly, QoS threshold file 108A can include information establishing a minimum QoS capability of the traffic. Where arbitration module 114 determines that the traffic exceeds QoS requirements of the first RAN, arbitration module 114 instructs switching module 116 to establish the second communication session for the AT over the second RAN. In at least some aspects of the subject disclosure, the second RAN can be identified as a RAN meeting the QoS requirements of the traffic. In at least one aspect of the subject disclosure, the second RAN can be a high speed packet access (HSPA) access network, and the AT can be a device that supports HSPA protocols. The first RAN can be, for instance, a high performance RAN, such as a third generation partnership project (3GPP) long term evolution (LTE) evolved universal terrestrial radio access network (e-UTRAN), or a WiFi access network, or a worldwide interoperability for microwave access (WiMAX) access network, or another suitable high performance RAN (e.g., high throughput, high data rate, etc.). Accordingly, in at least one aspect of the subject disclosure, the AT can comprise a multi-mode device that supports HSPA systems, as well as at least one of a LTE e-UTRAN system, a WiFi system, or a WiMAX system, or a similar system, or a suitable combination thereof.

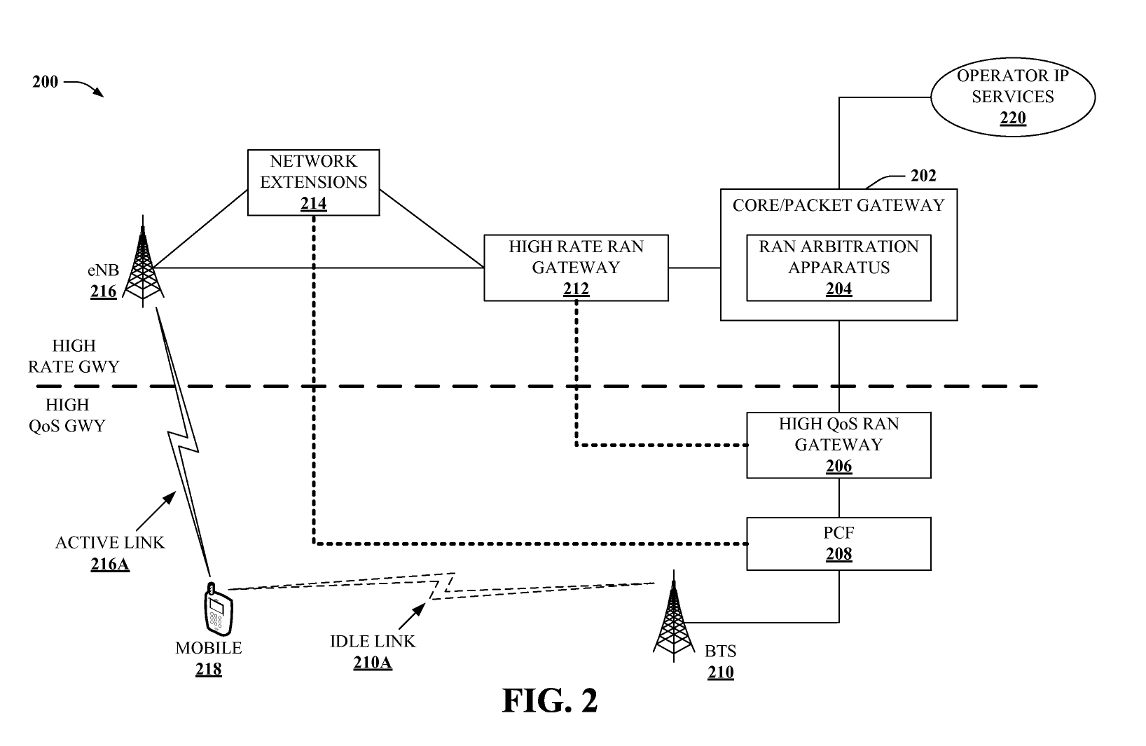

According to one particular aspect of the subject disclosure, context module 112 can be configured as a module that maintains the electronic communication session over the first RAN while the second communication session over the second RAN exists. For instance, context module 112 can maintain data session bindings (e.g., IP bindings, TCP/IP bindings, and so on) with the first RAN and a PDN gateway (not depicted, but see FIG. 2, infra) so that a data session involving the AT executed over the first RAN can persist, while the high QoS session is conducted over the second RAN. In other aspects of the subject disclosure, context module 112 can instead port the data session bindings with the first RAN over to the second RAN at least for the duration of the high QoS call. According to at least one further aspect, RAN arbitration apparatus 102 can further comprise a handover module 120 that instructs the AT to execute a handover to the second RAN to facilitate the second communication session. The handover instruction can be a result of a scenario in which arbitration module 114 identifies the wireless communication that is not supported by the first RAN, or upon completion of setup for the wireless communication on the second RAN. In at least one aspect, the handover instruction can be issued in conjunction with context module 112 porting the data session bindings with the first RAN over to the second RAN, for instance. In one case, the AT response to an invitation for the wireless communication prior to conducting a handover to the second RAN, and context module 112 completes setup of the wireless communication prior to establishing the second communication session over the second RAN. In an alternative aspect, the AT conducts the handover to the second RAN prior to responding to the invitation for the wireless communication. In an optional aspect, context module 112 establishes the second communication session prior to completing setup of the wireless communication.

According to one or more further aspects, RAN arbitration apparatus 102 can comprise a paging module 118 that can be configured as a module that sends a page to the AT when arbitration module 114 identifies a call invitation involving the AT that is not supported by the first RAN (e.g., exceeds QoS capabilities of the first RAN, has lower subscription rate on a second RAN, and so on). Paging module 118 can be employed e.g., if the call invitation terminates at the AT, for instance, instead of originating at the AT. In one aspect of the subject disclosure, the page can comprise an application-level signaling invitation (e.g., an SIP invitation) pertaining to the wireless communication. According to other aspects, upon identification of the call invitation, paging module 118 can route the page or the application-level signaling invitation directly over the first RAN to the AT, or through the second RAN, over a link that communicatively couples the first RAN to the second RAN, to a base station or switching center of the first RAN that serves the AT (e.g., see FIG. 2, supra, for an example of an inter-RAN communication link). In an alternative aspect, paging module 118 can instead forward the page for the high QoS call over the first RAN instead, optionally with an instruction by handover module 120 for the AT to handover to initiate an active link with the second RAN, or to activate a current passive link (e.g., limited to point to point protocol [PPP]) with the second RAN.

FIG. 2 depicts a block diagram of an example wireless communication network 200 according to aspects of the subject disclosure. Wireless communication network 200 can be operable to implement various aspects of the subject disclosure. For instance, wireless communication network 200 can be operable to implement arbitration between a plurality of RANs to provide access to different services of the respective RANs. Where arbitration is conducted dynamically, this can provide a seamless integration of services into wireless communications for multi-mode wireless devices.

Wireless communication network 200 can comprise a core network gateway, or PDN gateway 202 (referred to as a core/packet gateway 202), comprising a RAN arbitration apparatus 102. RAN arbitration apparatus 204 can be substantially similar to RAN arbitration apparatus 102 in at least one aspect of the subject disclosure, although it should be appreciated that the disclosure is not limited to this one aspect. In either case, RAN arbitration apparatus 204 can be operable to facilitate switching wireless connectivity for a mobile device 218 between a first RAN and a second RAN, based on characteristics of communication involving mobile device 218. In at least one aspect of the subject disclosure, the first RAN can be a high performance RAN, providing high throughput, or high data rate, or the like. The second RAN can be a high quality RAN, providing high QoS services. Thus, for high performance data sessions such as network browsing, or downloading content, RAN arbitration apparatus 204 can facilitate communication for mobile device 218 over the first RAN. For high QoS data sessions such as voice, voice over Internet protocol (VoIP), streaming audio or video, or the like, RAN arbitration apparatus 204 can facilitate communication for mobile device 218 over the second RAN. In at least one aspect of the subject disclosure, RAN arbitration apparatus 204 can facilitate simultaneous communication over respective RANs, facilitating high performance traffic over the first RAN and high QoS traffic over the second RAN.

Wireless communication network 200 comprises a first RAN which includes a high rate RAN gateway 212, an eNode B 216, and a network extensions entity 214, which provides suitable network addressing for inter-network communication (e.g., a multi-purpose Internet mail extension [MIME] entity, which can provide Internet protocol [IP] addressing for IP traffic, or the like). The second RAN can comprise a high QoS RAN gateway 206, a packet control function 208 (a PCF 208), and a base transceiver station 210 (a BTS 210). In one aspect of the subject disclosure, the second RAN can comprise a HSPA access network (where PCF 208 is an evolved access network [e-AN] packet control function), and the first RAN can comprise an LTE network, although the subject disclosure is not limited to this specific example.

In operation, wireless communication network 200 provides wireless communication services to mobile device 218, via wireless signaling conducted by eNodeB 216 or BTS 210. Further, the first RAN or second RAN can provide mobile device 218 with access to an operator's IP services through respective Internet control functions (e.g., network extensions entity 214 or PCF 208, respectively), and core/packet gateway 202. Further, RAN arbitration apparatus 102 can dynamically switch services for mobile device 218 from the first RAN, having high data rate capabilities, to the second RAN, having high QoS capabilities, or vice versa, based at least in part on characteristics of a call involving mobile device 218, and respective capabilities of the first and second RAN.

As one particular example, mobile device 218 can establish an active link 216A with eNodeB 216 for a high performance data session, and an idle link 210A with BTS 210. Active link 216A enables mobile device 218 to employ wireless services provided by a wireless operator associated with the first RAN. Idle link 210A allows mobile device 218 to monitor some control signaling of BTS 210 (e.g., paging signals, broadcast signals, timing signals, or the like), but not to employ services of a wireless operator associated with the second RAN (e.g., VoIP services).

If a high QoS call involving mobile device 218 is detected by RAN arbitration apparatus 204, a page is sent to mobile device 218 to notify such device of the high QoS call. In one aspect, the page can be routed through high rate RAN gateway 212 and eNodeB 216, even though the first RAN does not support the high QoS call itself. This aspect can be implemented where no communication link between the first RAN and second RAN exists, for instance. In other aspects, the page can be sent to second RAN instead. In the latter aspects, second RAN can utilize an inter-RAN communication link (the dotted line in FIG. 2) between PCF 208 and network extensions entity 214 to forward the page to mobile device 218. Upon receiving the page, mobile device 218 can activate idle link 210A. This notifies mobile device 218 to switch the idle link 210A to an active link, to participate in the high QoS call over the second RAN.

Once mobile device 218 activates idle link 210A, active link 216A can be terminated, or changed to an idle link, or can be maintained. If terminated, all communication with core/packet gateway 202 and operator's IP services 220 is conducted via BTS 210, PCF 208 and high QoS RAN gateway 206. In this case, data traffic being facilitated over active link 216A can be re-routed by high rate RAN gateway 212 to high QoS RAN gateway 206, via a direct communication link there between (depicted with the dotted line linking high rate RAN gateway 212 and high QoS RAN gateway 206, in wireless communication network 200). If no such direct communication link exists, data packets already sent to high rate RAN gateway 212 pertaining to this data traffic will be lost, and NACKed by mobile device 218 over BTS 210. Core/packet gateway 202 can forward the NACK to operator's IP services 220, which can resend the lost data packets. Once the high QoS call terminates, RAN arbitration apparatus 204 can re-establish communication session for the data traffic over the first RAN, and re-establish session bindings with high rate RAN gateway 212. Further, mobile device 218 can then re-activate activate link 216A, to continue the data traffic.

If mobile device 218 maintains active link 216A with eNodeB 216, the data traffic can continue over high rate RAN gateway 212 and eNodeB 216, while the high QoS call is conducted over high QoS RAN gateway 206, PCF 208 and BTS 210. Accordingly, it should be appreciated that RAN arbitration apparatus 204 can facilitate arbitration between the first RAN and the second RAN for high rate or high QoS calls, with or without the direct communication links coupling the respective RANs (the dotted lines connecting high rate RAN gateway 212 and high QoS RAN gateway 206, and connecting network extensions entity 214 and PCF 208, respectively). This can provide a significant advantage over conventional systems, which operate independently of other networks. As a result, wireless communication network 200 can provide seamless interoperability for a multi-mode mobile device (e.g., mobile device 218) providing optimal services of respective radio access networks.

FIG. 3 illustrates a block diagram of a sample wireless communication environment 300 according to aspects of the subject disclosure. Wireless communication environment 300 comprises a mobile communication apparatus 302 communicatively coupled with one or more wireless base stations. In one example of the subject disclosure, the one or more base stations can comprise an LTE eNode B 304 (also referred to as an LTE eNB 304) associated with a high performance RAN, and an evolved high rate packet data BTS 306 (also referred to as an eHRPD BTS 306) associated with a high stability RAN. It should be appreciated, however, that mobile communication apparatus 302 need not be coupled with LTE eNB 304 and eHRPD BTS 306 concurrently. However, in some aspects, mobile communication apparatus 302 can have an active link with one of the base stations, and an idle or passive link with the other base stations. In at least one aspect, mobile communication apparatus 302 can maintain active links with both LTE eNB 304 and eHRPD BTS 306.

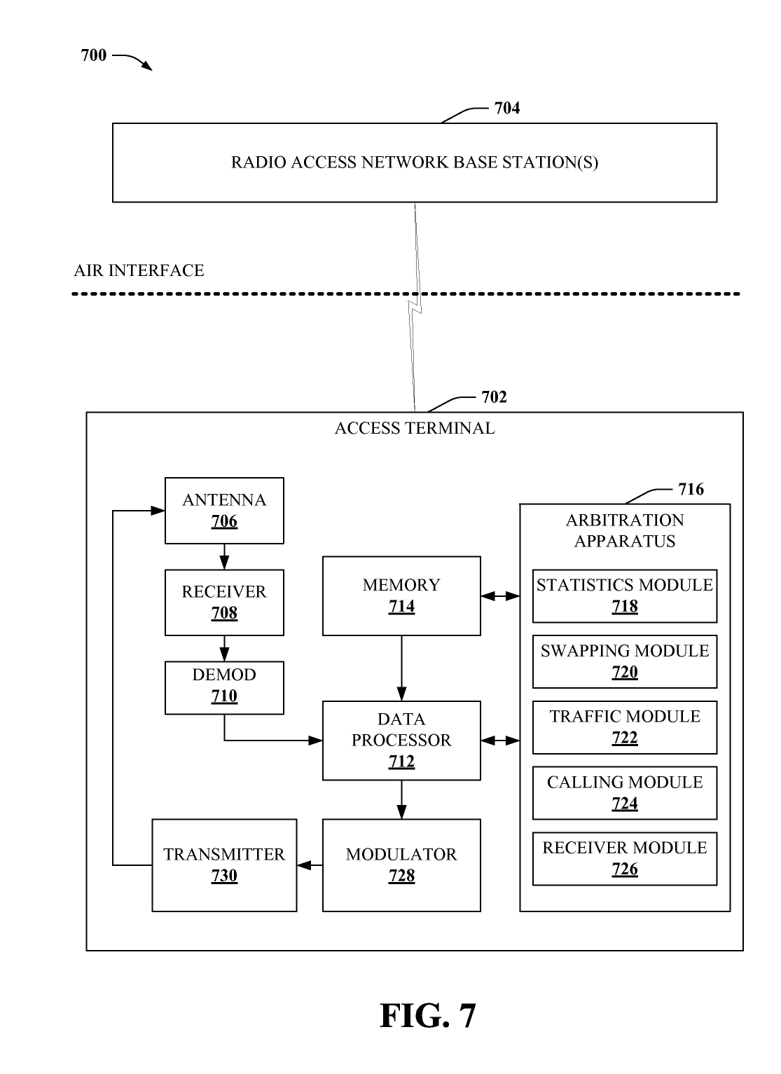

Mobile communication apparatus 302 can comprise a QoS swapping apparatus 310, configured to facilitate switching between LTE eNB 304 and eHRPD BTS 306 or vice versa, based at least in part on stability or performance characteristics of RANs in signaling range of mobile communication apparatus 302. QoS swapping apparatus 310 can comprise a communication interface that is configured to employ a wireless transceiver (not depicted, but see FIG. 7, infra) of mobile communication apparatus 302 to communicatively couple mobile communication apparatus 302 (and QoS swapping apparatus 310) with one or more of a plurality of RANs. Particularly, the plurality of RANs can comprise a high performance RAN associated with LTE eNB 304 and a high QoS RAN associated with eHRPD BTS 306. Thus, an active link coupling mobile communication apparatus 302 to LTE eNB 304 can be referred to as a high data rate session, whereas an active link coupling mobile communication apparatus 302 to eHRPD BTS 306 can be referred to as a high QoS session, or high stability session (see below). Furthermore, QoS swapping apparatus 310 can comprise memory 312 for storing instructions configured for selecting different ones of the plurality of RANs based at least in part on QoS requirements of traffic involving mobile communication apparatus 302, and a data processor 314 that executes modules to implement the instructions.

Modules for selecting among the different RANs based on traffic requirements can comprise a network statistics module 318 and a swapping module 320. Network statistics module 318 can be configured to be a module that references stability or performance characteristics of one or more of the plurality of RANs based at least on stability requirements of an anticipated call session. In one aspect, the anticipated call session can be derived or inferred from a page transmitted to mobile communication apparatus 302 by LTE eNB 304 or eHRPD BTS 306. As one particular example, the page can be related to a session IP (SIP) invite 308 pertaining to a VoIP call session. Referencing stability or performance characteristics can comprise maintaining a look-up table of such characteristics as a function of respective RANs in memory 312, or querying LTE eNB 304 or eHRPD BTS 306 to obtain such information, or the like. Once obtained, characteristics of respective RANs can be forwarded to swapping module 320.

Swapping module 320 can be configured to be a module that dynamically switches an active link of mobile communication apparatus 302 from a preferred RAN having high performance capabilities (e.g., LTE eNB 304) to a reliable RAN (e.g., eHRPD BTS 306) having high stability capabilities (high QoS). Switching from one RAN to another can be conditioned on whether a call session requiring high stability (also referred to as a high stability session) is initiated at or received by mobile communication apparatus 302. In operation, swapping module 320 can select the reliable RAN based on traffic stability of respective RANs of the plurality of RANs provided by network statistics module 318. Further, upon termination of the high stability session, swapping module 320 optionally dynamically switches the active link to the preferred RAN (e.g., LTE eNB 304).

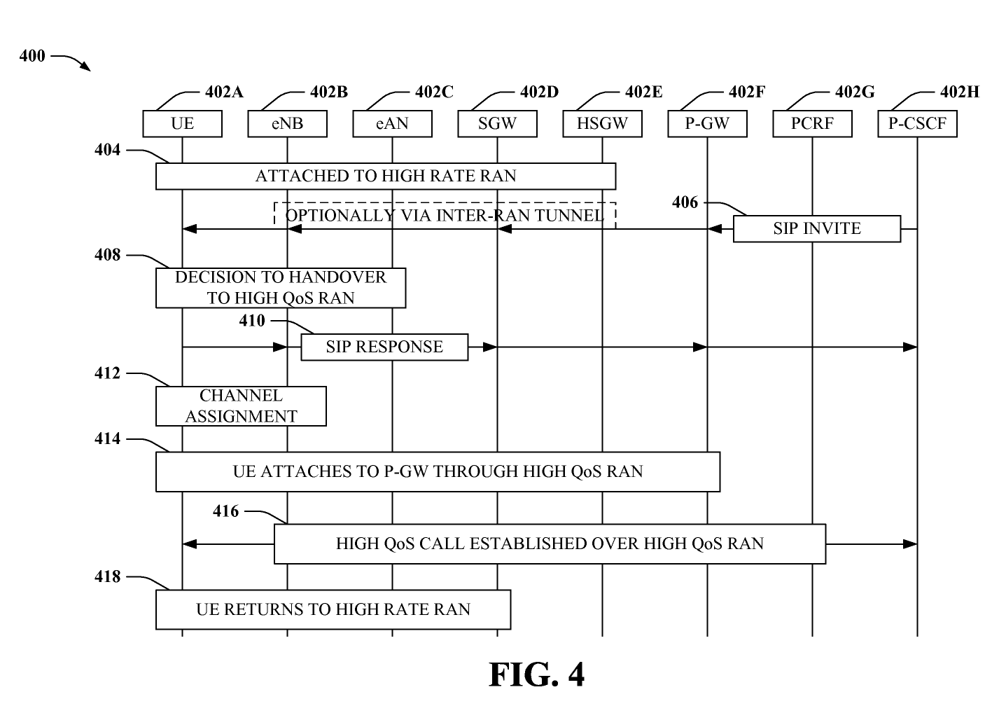

FIG. 4 depicts a diagram of an example network control flow 400 providing dynamic network access as a function of call session requirements, according to one or more aspects of the subject disclosure. Network control flow 400 involves several components of a wireless network, including core network components, operator network components, and RAN components. Particularly, network control flow 400 involves a user equipment 402A (a UE 402A), an eNB 402B, an enhanced access network 402C (an eAN 402C), a serving gateway 402D (an SGW 402D), an HRPD SGW 402E (also referred to as an HSGW 402E), a packet gateway 402F (P-GW 402F), a policy and charging rule function 402G (a PCRF 402G), and a proxy call session control function 402H (a P-CSCF 402H).

At 404, UE attaches to a first RAN (e.g., a best effort RAN, a high rate RAN, a low service cost RAN, etc) via eNB 402B. The first RAN can comprise an LTE RAN, an advanced LTE (LTE-A) RAN, or other suitable high throughput or high data rate RAN, or a RAN providing best effort QoS (e.g., at a reduced subscription rate, or relatively low subscription rate), or a RAN providing a fixed, pre-paid or subscription-less service (e.g., a WiFi RAN coupled to the Internet), or the like, or a suitable combination thereof (It should be appreciated that the relative term ‘high’ in regard to high throughput or high rate refers to a comparison between a high rate RAN and another RAN in wireless signaling range of UE 402A that provides QoS suitable for VoIP calling, streaming audio or video, or like high QoS applications. It is to be noted that the term ‘high’ as utilized in ‘high performance’ is not necessarily a constant metric of throughput or data rate; rather, it is intended in at least some aspects of the subject disclosure to be a purely relative term, based on comparison to other RANs in signaling range of UE 402A. Where no other networks are available, or no other networks having lower performance characteristics than the high rate RAN, the term ‘high performance’ may be inoperative. In other aspects, however, ‘high performance’ can be a constant metric for a geographic region, for an operator's RAN deployments, or the like).

At some point after UE 402A is attached to the first RAN, P-CSCF 402H sends an SIP invite 406 to P-GW 402F, which forwards the SIP invite to UE 402A via eNB 402B, which is associated with the first RAN. The SIP invite 406 is an invite pertaining to a call session requiring high QoS. Examples can include a VoIP session, a streaming data session, a streaming audio session, or other suitable high QoS call session, or a suitable combination thereof.

In one aspect of the subject disclosure, UE 402A attaches both to the first RAN, and to a second RAN (e.g., a high stability RAN, such as an eHRPD RAN associated with eAN 402C that provides high QoS). UE 402A can maintain an active link with the first RAN while engaging in data sessions such as Internet browsing, text messaging, or other data services where specific QoS is not required. Additionally, UE 402A can maintain a passive or idle link with the second RAN, in the event that QoS is required for a call, such as VoIP (e.g., maintaining the second RAN in part of an active set of base stations). In this aspect(s) of the subject disclosure, SIP invite 406 can be forwarded via the first RAN to SGW 402D and eNB 402B, as discussed above. This aspect can be implemented where no inter-RAN communication link between the first RAN and the second RAN exists, for instance. Where such an inter-RAN communication link does exist, however, SIP invite 406 could alternatively be forwarded to HSGW 402E instead. HSGW 402E could then tunnel SIP invite 406 eAN 402C, for instance. In such case, eAN 402C can then forward SIP invite 406 to UE 402A, as above.

At 408, UE 402A makes a decision to handover to the second RAN in response to receiving SIP invite 406. Following, or as part of, the decision, UE 402A sends an SIP response 410 to eNB 402B, which forwards SIP response 410 to P-GW 402F via SGW 402D. Alternatively, UE 402A could optionally tunnel SIP response 410 to eAN 402C via the inter-RAN communication link discussed above. In this case, eAN 402C forwards SIP response 410 to HSGW 402E, which in turn forwards SIP response 408 to P-GW 402F. Once received, P-GW 402F can then responds to P-CSCF with SIP response 410, which employs SIP response 410 to setup the high QoS call.

At 412, UE 402A receives a channel assignment pertaining to the high QoS call. The channel assignment can be tunneled to UE 402A, by way of eAN 402C and eNB 402B via a communication link between eAN 402C and eNB 402B (e.g., see FIG. 2, supra). At 414, UE 402A attaches to P-GW through the second RAN (or high QoS RAN). At 416, the high QoS call is established over the second RAN. Finally, at 418, UE can optionally return to the first RAN upon termination of the high QoS call, by re-attaching to eNB 402B, and releasing an attachment to eAN 402C, or de-activating the attachment to eAN 402C.

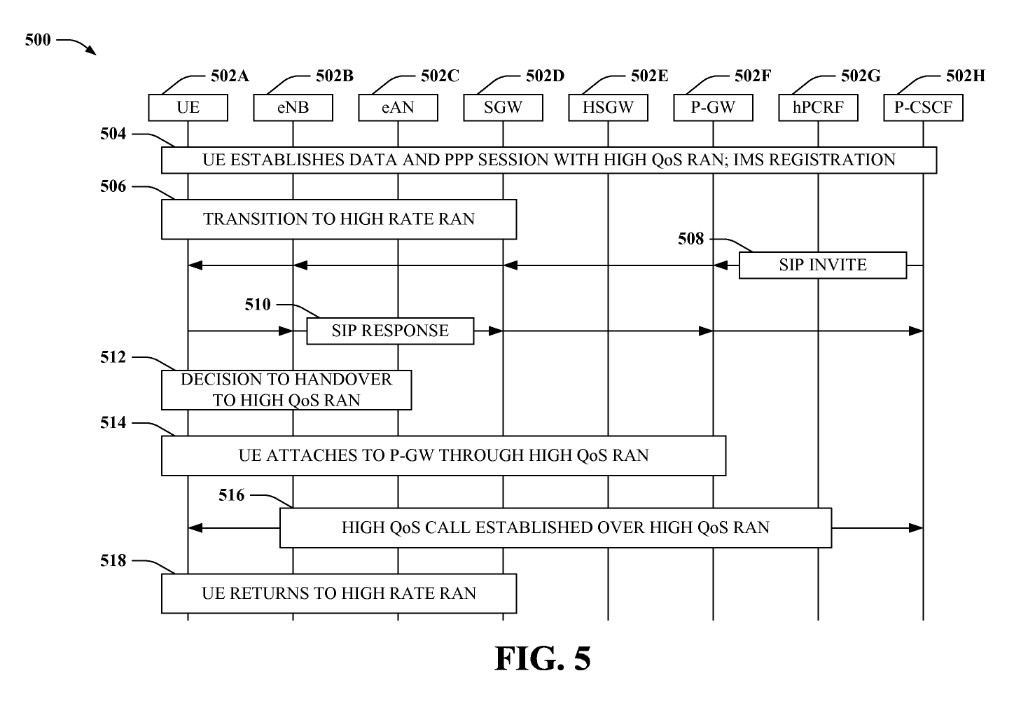

FIG. 5 illustrates a diagram of an example network control flow 500 according to additional aspects of the subject disclosure. Network control flow 500 can be implemented, for instance, when a preferred network (e.g., high throughput or high data rate access network, low cost/fixed cost/free access network, or best effort access network) is communicatively coupled to an IP multimedia subsystem (IMS) PDN-GW, or a similar packet network gateway. Similar to network control flow 400, supra, network control flow 500 involves several network components, including a UE 502A, eNB 502B, eAN 502C, SGW 502D, HSGW 502E, P-GW 502F, PCRF 502G and P-CSCF 502H, respectively.

At 504, UE 502A attaches to a second RAN suitable for supporting a QoS call, such as a high stability RAN, a high QoS RAN, or as a more specific example, an eHRPD RAN, and establishes a point to point protocol (PPP) session and IMS registration with a HSGW 502E associated with the second RAN. At 506, UE 502A transitions to a preferred RAN, maintaining the PPP session with the second RAN. P-CSCF 502H forwards an SIP invite 508 to eNB 502B, via P-GW 502F and SGW 502D. The SIP invite 508 is provided to UE 502A by eNB 502B. Upon receiving SIP invite 508, UE 502A immediately sends an SIP response 510 to eNB 502B. The SIP response 510 then is communicated to SGW 502D, P-GW 502F, and finally to P-CSCF 502H, which can setup the SIP session associated with SIP invite 508.

At 512, UE 502A conducts a decision to handover to the second RAN. At 514, UE 502A attaches to P-GW 502F through the second RAN (specifically, eAN 502C and HSGW 502E). Additionally, at 516, P-CSCF 502H, P-GW 502F, HSGW 502E, and eAN 502C can establish the high QoS call in conjunction with UE 502A. Upon termination of the high QoS call, UE 502A can optionally return to the preferred RAN at 518.

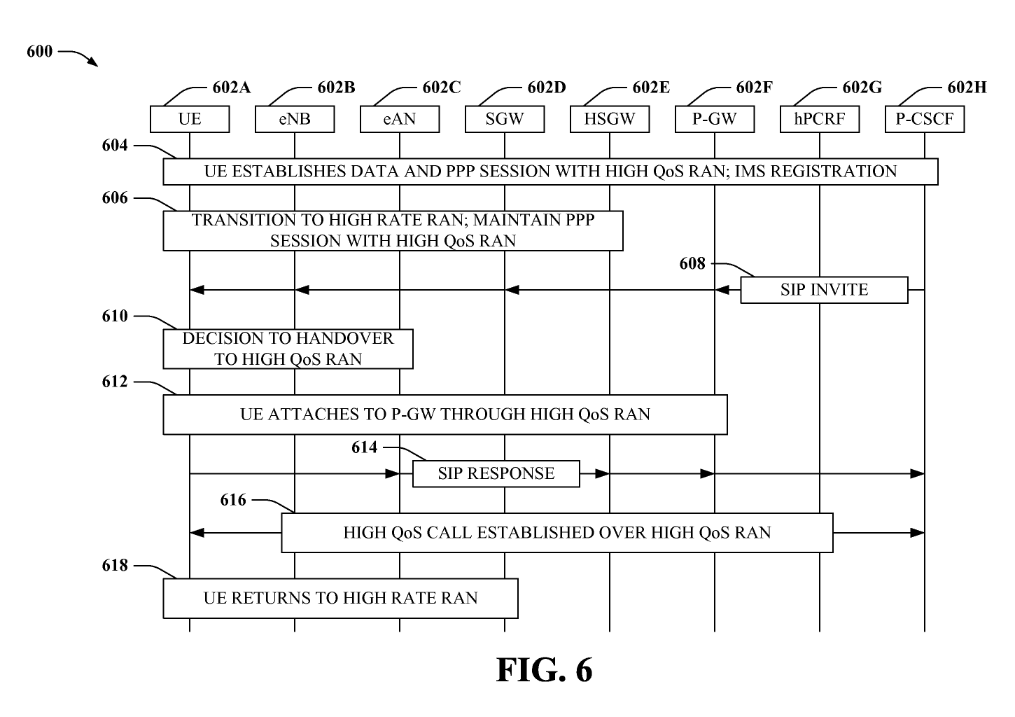

FIG. 6 is a diagram of an alternative network control flow 600 according to additional aspects of the subject disclosure. Like network control flow 500, supra, network control flow 600 can comprise wireless network components including UE 602A, eNB 602B, eAN 602C, SGW 602D, HSGW 602E, P-GW 602F, PCRF 602G and P-CSCF 602H. At 604, UE 602A establishes a data session with eAN 602C, and performs a PPP registration with HSGW 602E, and an IMS registration with P-GW 602F. At 606, UE 602A transitions to a preferred RAN, as described herein, while maintaining the PPP registration with the high QoS RAN. P-CSCF 602H sends an SIP invite 608 to UE 602A, via P-GW 602F, SGW 602D, and eNB 602B. At 610, UE 602A first determines to handover to a second RAN (e.g., a high QoS RAN) in response to SIP invite 608 (in contrast to FIG. 5, supra, where UE 502A first determined to send SIP response 510 before handing over). At 612, UE 602A attaches to P-GW 602F through the high QoS RAN (specifically eAN 602C and HSGW 602E). At 616, the high QoS call is established over the second RAN, similar to 516 if FIG. 5, supra. Further, at 618, UE 602A optionally returns to the preferred RAN upon termination of the high QoS call.

FIG. 7 illustrates a block diagram of an example system comprising an AT 702 configured for wireless communication according to aspects of the subject disclosure. AT 702 can be configured to wirelessly couple with one or more base stations 704 (e.g., access point) of a wireless network. Based on such configuration, AT 702 can receive wireless signals from a plurality of base stations 704 on a forward link channel and respond with wireless signals on a reverse link channel. In addition, AT 702 can comprise instructions stored in memory 714 for selecting different ones of a plurality of RANs based at least on attributes of a wireless communication, attributes of services or applications involved in the wireless communication, respective sets of capabilities of respective RANs of the plurality of RANs, operator/OEM service preferences, features, or restrictions, or the like, as described herein.

AT 702 includes at least one antenna 706 (e.g., a wireless transmission/reception interface or group of such interfaces comprising an input/output interface) that receives wireless signals and receiver(s) 708, which performs typical actions (e.g., filters, amplifies, down-converts, etc.) on the received signal. Further, AT 702 can comprise antenna(s) 706 or receivers 708 to receive and act upon, respectively, a plurality of wireless signals from plurality of base stations 704. In general, antenna(s) 706 and one or more transmitters 730 can be configured to transmit wireless signals to base stations 704. Moreover, it should be appreciated that antenna(s) 706, receiver 708, and transmitter 730, as well as a demodulator 710 and a modulator 728, can form a set of wireless transceivers for implementing the data exchange between base station(s) 704 and AT 702.

Antenna(s) 706 and receiver(s) 708 can be coupled with demodulator 710 that can demodulate received symbols and provide such signals to a data processor(s) 712 for evaluation. It should be appreciated that data processor(s) 712 can control and/or reference one or more components (antenna(s) 706, receiver 708, demodulator 710, memory 714, arbitration apparatus 716, network statistics module 718, swapping module 720, traffic module 722, calling module 724, receiver module 726, modulator 728, transmitter 730) of AT 702. Further, data processor(s) 712 can execute one or more modules, applications, apparatuses, engines, or the like (e.g., arbitration apparatus 716) that comprise information or controls pertinent to executing functions of AT 702. For instance, such functions can include swapping between the plurality of RAN base stations 704 based on requirements of current calls, and characteristics of respective base stations 704, as described herein.

Additionally, memory 714 of AT 702 is operatively coupled to data processor(s) 712. Memory 714 can store data to be transmitted, received, and the like, and instructions suitable to conduct wireless communication with a remote device. Further, memory 714 can at least in part store, or be communicatively coupled, with arbitration apparatus 716 that facilitates swapping among the plurality of RAN base stations 704 based at least on attributes of a wireless communication, or on capabilities of the base stations, or calls involving AT 702. Particularly, arbitration apparatus 716 can comprise a network statistics module 718 that references characteristics (e.g., stability or QoS characteristics, throughput characteristics, data rate characteristics, operator/OEM subscription-based characteristics such as charging, low cost or fixed cost services, and so on) of one or more of the plurality of RAN base stations 704 based at least on attributes of an anticipated wireless session, and a swapping module 720 that dynamically switches from a preferred RAN having a first set of capabilities (e.g., high throughput or data rate capabilities) to a reliable RAN having a second set of capabilities (e.g., specific level of QoS), if a wireless session is initiated at or received by AT 702, and if the second set of capabilities provide preferable service or cost for the wireless session over the first set of capabilities.

According to particular aspects of the subject disclosure, arbitration apparatus 716 can further comprise a traffic module 722 that transitions network bindings established for an existing data session among one or more of the plurality of RAN base stations 704. In one aspect, traffic module 722 transitions network bindings associated with a data session maintained at a preferred RAN of the plurality of RAN base stations 704 (e.g., a high performance LTE network) to a second RAN (e.g., a QoS RAN) of the plurality of RAN base stations 704 upon initiation or receipt of the wireless session. In an alternative aspect, however, traffic module 722 maintains the network bindings on the preferred RAN while the wireless session is conducted on the second RAN.

In one or more additional aspects, arbitration apparatus 716 can comprise a calling module 724 that initiates data sessions (e.g., including the wireless session referenced above) for the apparatus. In one aspect, calling module 724 can be a module that initiates high QoS data sessions for AT 702, such as VoIP data sessions, streaming video data sessions, or streaming audio data sessions. As a particular example, calling module 724 can be configured to be a module that forwards a QoS or subscription attribute of the wireless session to network statistics module 718. In response, calling module 724 can obtain respective sets of capabilities for a subset of the plurality of RAN base stations 704. Based on the set of stability or performance characteristics, calling module 724 instructs swapping module 720 to switch from the preferred RAN to the second RAN if the QoS or subscription attribute of the wireless session is not supported by the preferred RAN. In such case, calling module 724 initiates the wireless session once AT 702 is connected to the second RAN.

In an additional aspect, arbitration apparatus 716 can comprise a receiver module 726 that obtains and analyzes session invites sent to AT 702 from the preferred RAN (or, e.g., from one or more other RAN base stations 704 communicatively coupled to AT 702). In a similar manner as calling module 724, receiver module 726 obtains a QoS or subscription-based capability of the preferred RAN from network statistics module 718 upon analyzing a session invite (e.g., an SIP invite) for the wireless session. Further, receiver module 726 compares a QoS or subscription attribute of the wireless session to the QoS or subscription capability and instructs swapping module 720 to dynamically switch from the preferred RAN to the second RAN if the QoS or subscription capability does not support the QoS or subscription attribute.

The aforementioned systems and apparatuses have been described with respect to interaction between several components, modules and/or communication interfaces. It should be appreciated that such systems and components/modules/interfaces can include those components/modules or sub-modules specified therein, some of the specified components/modules or sub-modules, and/or additional modules. For example, a system could include AT 702 comprising RAN arbitration apparatus 102, and core/packet gateway 202, comprising RAN arbitration apparatus 204, or a different combination of these or other modules. Sub-modules could also be implemented as modules communicatively coupled to other modules rather than included within parent modules. Additionally, it should be noted that one or more modules could be combined into a single module providing aggregate functionality. For instance, arbitration module 114 can include switching module 116, or vice versa, to facilitate analyzing QoS requirements of traffic and transitioning a mobile device among wireless access networks based on QoS capabilities of respective networks, by way of a single component. The components can also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

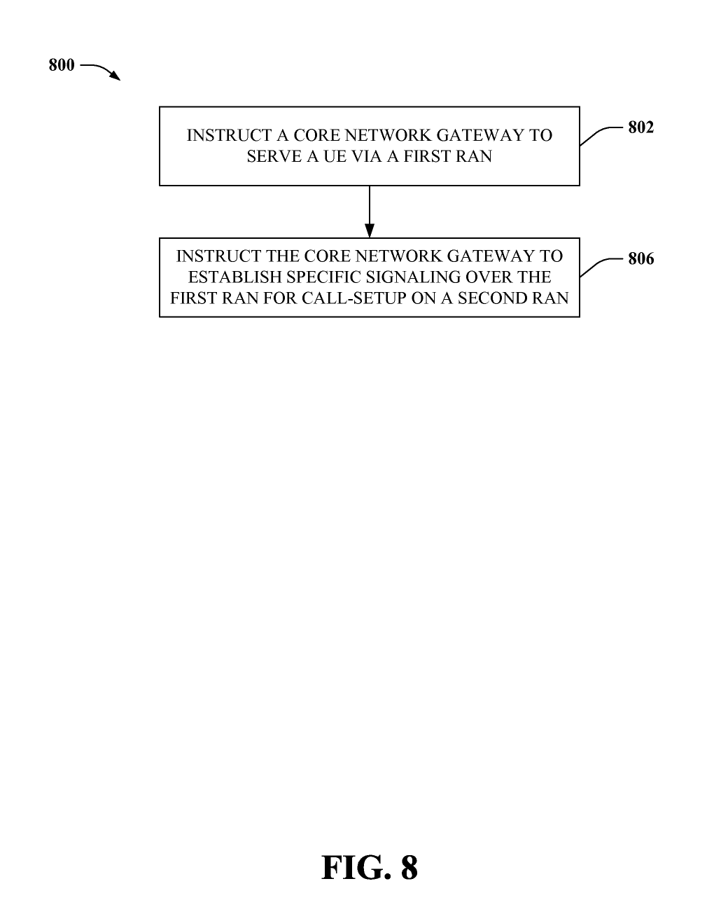

In view of the exemplary systems described supra, methodologies that may be implemented in accordance with the disclosed subject matter will be better appreciated with reference to the flow charts of FIGS. 8-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, device in conjunction with a carrier, or storage medium.

FIG. 8 illustrates a flowchart of an example methodology 800 for providing various aspects of the subject disclosure. At 802, method 800 can comprise instructing a wireless core network gateway to provide wireless communication service to a mobile device via a first RAN. The wireless communication service can comprise, for instance, a service that provides best effort QoS, or a particular cost or charging subscription rate, or a particular level for overall high throughput or high data rates. As one particular example, providing the wireless communication service can further comprise employing a core network processing entity (e.g., an arbitration apparatus implemented in conjunction with the core network gateway, or another suitable entity within a core network or an operator's network) to identify an application or wireless session associated with the application or session specific signaling that includes the mobile device as a participant of the call. Further, employing the core network processing entity to identify the specific QoS call could also comprise receiving an invitation for the application or wireless session that is initiated by or that targets the mobile device. The invitation can be referred to as a mobile initiated or mobile terminated call, if it is initiated by or targets the mobile device, respectively. The invitation can be received from the mobile device via the first RAN or the second RAN if the invitation is initiated by the mobile device, or can be received from a network gateway if the invitation targets the mobile device.

Further to the above, at 804, method 800 can comprise instructing the wireless core network gateway to establish session or application specific signaling at least in part over the first RAN for a wireless communication to be conducted over the second RAN. The session or application specific signaling can comprise establishing a context for the mobile device on a second RAN, for instance, performing an Internet Protocol mobility service (IMS) registration for the mobile device, or performing signaling for the IMS registration over the first RAN, establishing a PPP context for the mobile device, and performing signaling for the PPP context over the first RAN, or the like. In at least one aspect, the second RAN can be a RAN that provides QoS service, throughput, or subscription service sufficient to support the wireless communication (e.g., a HRPD RAN). In at least one additional aspect, the application or session specific signaling pertains to a specific QoS call, or a low or fixed cost call, and further wherein the first RAN does not support the specific QoS call, or the low or fixed cost call.

In some particular examples, method 800 can comprise at least one of: maintaining the wireless communication service on the first RAN while an application or wireless session associated with the application or session specific signaling is conducted on the second RAN, or transferring a wireless communication associated with the wireless communication service on the first RAN to the second RAN following a handover of the mobile device to the second RAN. In at least one aspect, maintaining the wireless communication service on the first RAN can comprise routing traffic of the wireless communication service to the second RAN via a communication link between the first RAN and the second RAN. In an alternative aspect, however, maintaining the wireless communication service on the first RAN can comprise employing the wireless core network gateway to establish a packet context for the mobile device on the second RAN, and routing traffic from the wireless core network gateway to a gateway of the second RAN.

According to another example, method 800 can comprise establishing the an application or wireless session associated with the application or session specific signaling directly to the second RAN, and terminating a context for the application or wireless session on the second RAN or switching the context to the first RAN when the application or wireless session is terminated. As yet another example, establishing the application or wireless session can comprise sending a channel assignment for the second RAN to the mobile device via the communication link between the first RAN and the second RAN. In one aspect of this example, sending the channel assignment can comprise routing the channel assignment for the second RAN to the mobile device via a network gateway of the first RAN.

According to still other examples, establishing the high QoS call can comprise initiating or effecting a handover of the mobile device from the first RAN to the second RAN in conjunction with establishing an application or wireless session associated with the application or session specific signaling. In a further example, establishing the application or wireless session can optionally comprise sending a paging message to the mobile device via the second RAN upon receiving the invitation. The paging message can be routed over a connection between the second RAN and the first RAN if the application or wireless session targets the mobile device. As an alternative example, however, establishing the application or wireless session can comprise receiving the invitation for the application or wireless session from the mobile device via the first RAN or the second RAN, if the invitation is initiated by the mobile device.

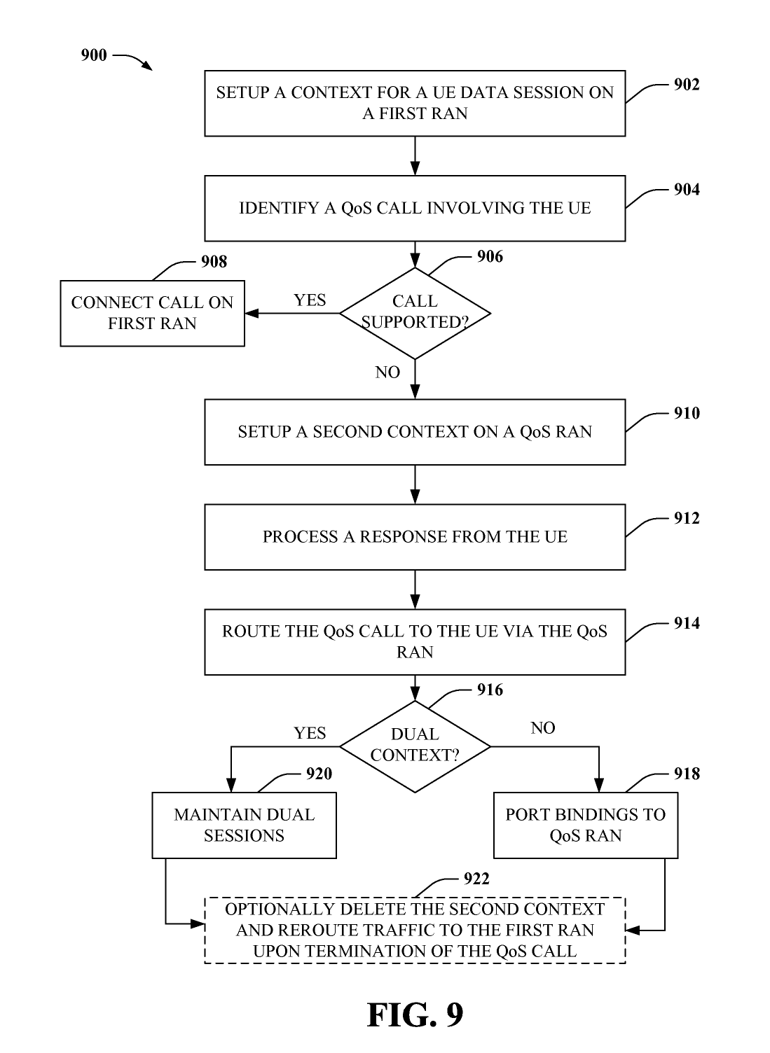

FIG. 9 depicts a flowchart of an alternative methodology 900 according to one or more other aspects of the subject disclosure. At 902, method 900 can comprise setting up a context for a user equipment (UE) data session on a first RAN. The first RAN can be a default RAN, which provides high throughput or data rates, on a best effort service plan, for instance. Further, method 900 at 904 can comprise identifying a QoS call (e.g., a VoIP call, streaming video call, streaming audio call, or the like, or a suitable combination thereof) involving the UE. At 906, a determination can be made as to whether the QoS call is supported by the first RAN. If the first RAN can support the QoS call, method 900 proceeds to 908. Otherwise, method 900 can proceed to 910.

At 908, method 900 connects the QoS call for the mobile device over the first RAN. Method 900 can then terminate after 908. At 910, method 900 can comprise setting up a second context for the mobile device on a QoS RAN (e.g., a RAN that supports a level of QoS sufficient to implement the QoS call). At 912, method 900 can comprise processing a response from the UE to the QoS call. (In at least one aspect, however, processing the response from the UE can be performed prior to setting up the second context for the mobile device on the high QoS RAN instead). At 914, method 900 can comprise routing the QoS call to the UE via the QoS RAN. At 916, a determination is made as to whether a dual context over the first RAN and the QoS RAN should be maintained concurrently. The determination can be based on a subscription type associated with communication services of the UE, capabilities of the first RAN or the QoS RAN, respective network loading of the first RAN or QoS RAN, or the like. If the dual context is maintained, method 900 can proceed to 920. Otherwise, method 900 proceeds to 918.

At 918, method 900 can comprise porting bindings associated with the context established on the first RAN at reference number 902 to the QoS RAN. After porting the bindings, method 900 can optionally proceed to 922. At 920, method 900 can comprise maintaining dual sessions for the UE on the first RAN and the QoS RAN. Particularly, data sessions sufficient for best effort traffic can be conducted over the first RAN, whereas the QoS call is conducted over the QoS RAN. At 922, method 900 can optionally comprise deleting the second context and re-routing traffic to the first RAN upon termination of the QoS call.

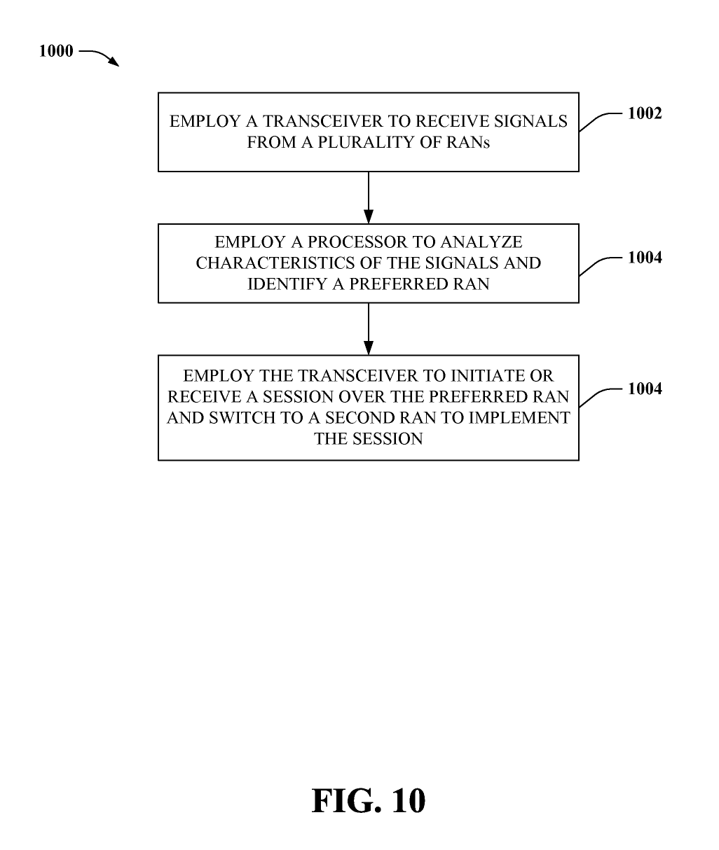

FIG. 10 depicts a flowchart of an example methodology 1000 for facilitating arbitration among networks based on characteristics of respective networks and requirements of anticipated wireless calls. At 1002, method 1000 can comprise employing a wireless transceiver to receive wireless signals from a plurality of RANs. Particularly, the plurality of RANs can comprise at least one RAN that offers high data rate services at a best effort service policy, and at least one RAN that offers QoS services suitable for a high QoS policy configured for high QoS wireless calls. At 1004, method 1000 can comprise employing a data processor to analyze characteristics of the wireless signals and select a preferred RAN from the plurality of RANs having highest signal performance. In the context of method 1000, the preferred RAN can comprise the at least one RAN that offers high data rate services at the best effort service policy. Additionally, at 1006, method 1000 can comprise employing the wireless transceiver to initiate or receive an application or session over the preferred RAN, and to activate a link with a second RAN of the plurality of RANs that supports the application or session (e.g., if the preferred RAN lacks capabilities to support the application or session). According to one aspect of the subject disclosure, the application or session comprises a high QoS call, or a low cost or fixed cost call. In another aspect of the subject disclosure, if the link with the second RAN fails to be properly implemented via signaling over the first RAN, method 1000 can also comprise switching or handing off to the second RAN, and initiate the application or session directly with the second RAN. Optionally, switching or handing off to the second RAN can comprise a network initiated order for the handing off.

Several specific implementation examples for method 1000 are now described. It should be appreciated that some, all or none of these specific examples can be implemented for a suitable wireless communication. In one aspect, employing the wireless transceiver to receive the high QoS call can further comprise receiving an invite for the application or session from a serving base station of the preferred RAN. This can be contrary to conventional QoS deployments, which typically require QoS services to be paged and setup over QoS RANs, instead. In another example, method 1000 can comprise first responding to the application or session over the preferred RAN, and then performing a handover to a base station of the second RAN to conduct the application or session. Alternatively, method 1000 can comprise first performing the handover to the base station of the second RAN and then responding to the application or session over the second RAN. As yet another example implementation, method 1000 can comprise maintaining the application or session over the second RAN concurrently with a data session established over the preferred RAN. In an alternate aspect, however, method 1000 can comprise porting the data session established over the preferred RAN to the second RAN upon activating the link with the second RAN. In one or more other example implementation, method 1000 can comprise first terminating the data session established with the preferred RAN prior to establishing the link with the second RAN for the application or session. In this latter example, the data session established with the preferred RAN can optionally be maintained or re-initiated over the second RAN concurrently with the high QoS call, if supported by the second RAN.

In yet another example implementation, method 1000 can comprise establishing the link with the second RAN and performing an IMS registration upon selecting the preferred RAN, and maintaining the link with the second RAN as inactive until receiving indication that the preferred RAN lacks QoS capabilities to support the application or session. For instance, performing the IMS registration with the second RAN can comprise performing the IMS registration to activate the application or session, wherein the signaling associated with the IMS registration is conducted over the preferred RAN, or optionally over the second RAN. As another option, performing the IMS registration can comprise conducting IMS signaling associated with the IMS registration and IMS signaling associated with setup of the application or session over the preferred RAN, or over the second RAN. According to yet another aspect, establishing the link with the second RAN can additionally comprise at least one of: deactivating the first link with the preferred RAN upon activating the link with the second RAN; or activating the link with the second RAN upon receiving a command from the preferred RAN to conduct a handover to the second RAN, or upon receiving a page or an application-level signaling invitation for the application or session (e.g., an SIP invitation) directly over the first link with the first RAN, or from the second RAN routed over the first link via a side-haul link between the first RAN and the second RAN.

Optionally, this example can comprise re-activating the link with the preferred RAN upon termination of the application or session. As an alternative to this example, method 1000 can comprise activating the link with the second RAN upon receiving a command from the preferred RAN to conduct a handover to the second RAN, or upon receiving the page or the application-level signaling invitation from the first RAN (e.g., whether directly over the first RAN, tunneled from the second RAN to the first RAN, or over the (inactive) link with the second RAN).

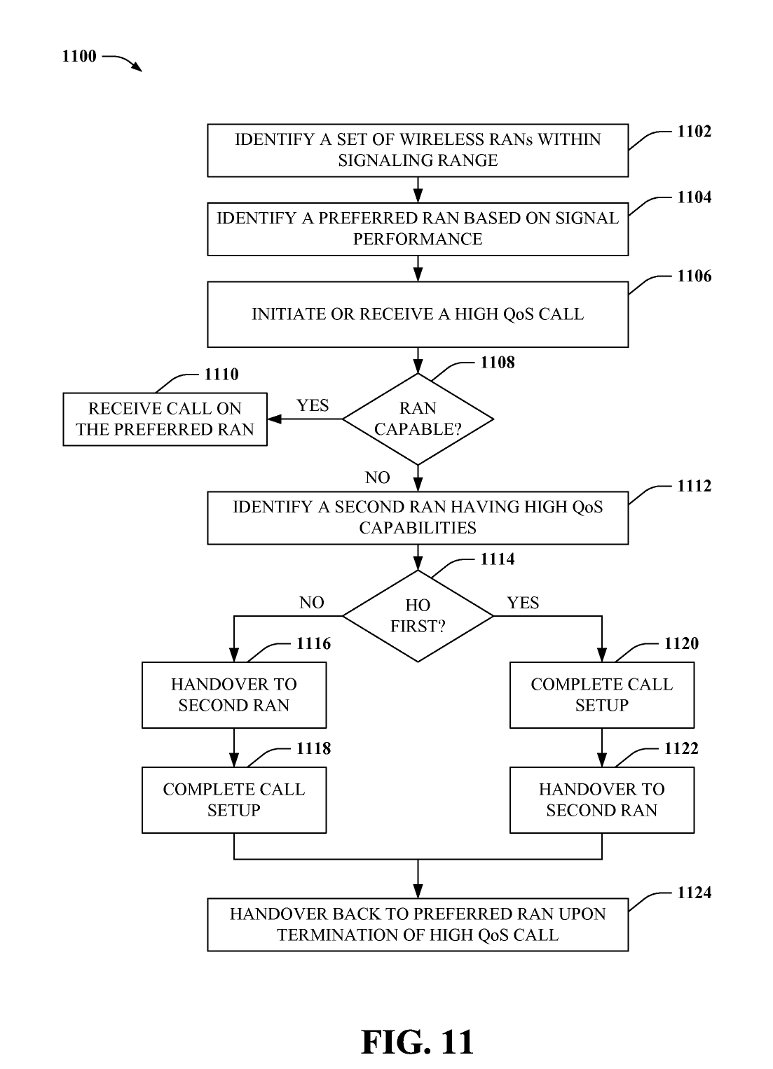

FIG. 11 illustrates a flowchart of an example methodology 1100 according to still other aspects of the subject disclosure. At 1102, method 1100 can comprise identifying a set of wireless RANs within a signaling range of a mobile device. At 1104, method 1100 can comprise identifying a preferred RAN based on signal performance of respective RANs of the set of RANs. At 1106, method 1100 can comprise initiating or receiving a high QoS call. At 1108, a determination is made as to whether the preferred RAN is capable of supporting the high QoS call. If so, method 1100 proceeds to 1110. Otherwise, method 1100 can proceed to 1112.

At 1110, method 1100 can comprise receiving the high QoS call on the preferred RAN. After receiving the high QoS call on the preferred RAN, method 1100 can terminate. At 1112, method 1100 can comprise identifying a second RAN of the set of wireless RANs having high QoS capabilities. The identifying can be based on analysis of wireless signals of the second RAN, by querying one or more of the wireless RANs for QoS capabilities, or referencing a look-up table that provides QoS capabilities of respective RANs of the set of RANs, or another suitable mechanism.

At 1114, a determination is made as to whether a handover to the second RAN should be implemented immediately. The determination can be based on handover protocols of the preferred RAN or the second RAN, protocols of the mobile device, an instruction from the preferred RAN or the second RAN, or the like. If the handover is conducted first, method 1100 proceeds to 1120. Otherwise, method 1100 can proceed to 1116.

At 1116, method 1100 can conduct a handover for the mobile device to the second RAN. At 1118, method 1100 can respond to or receive a response pertaining to, the high QoS call (depending on whether the high QoS call terminates at or originates at the mobile device, respectively). Method 1100 can then proceed to 1124.

At 1120, method 1100 can comprise completing setup of the high QoS call, either by responding to the high QoS call if mobile terminated, or receiving such a response if mobile initiated. At 1122, method 1100 can comprise conducting the handover for the mobile device to the second RAN. At 1124, method 1100 can comprise conducting a handover to the preferred RAN upon termination of the high QoS call.

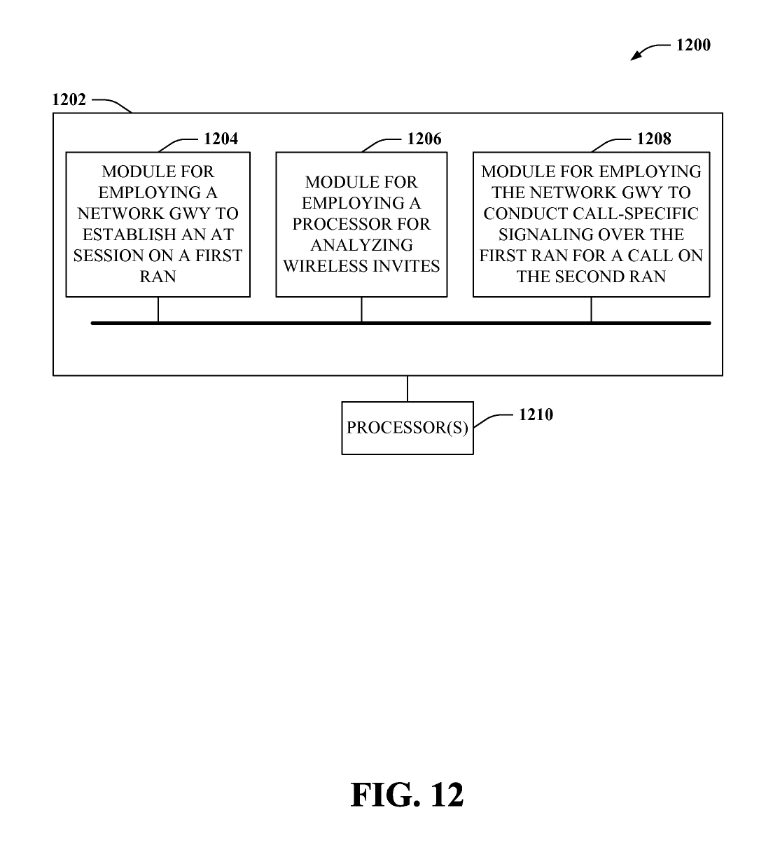

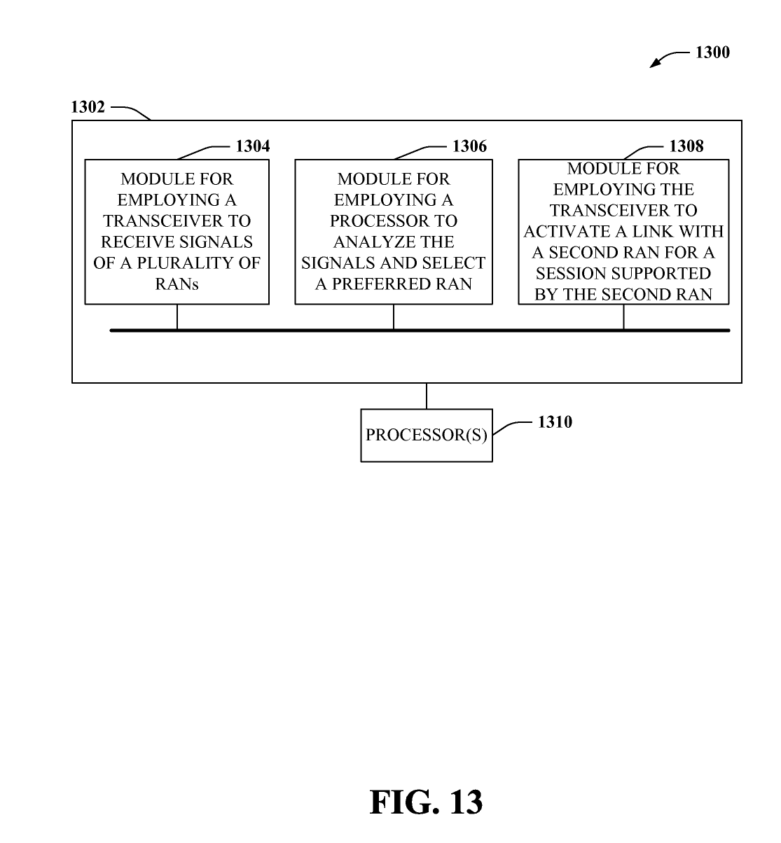

FIGS. 12 and 13 illustrate respective example systems 1200, 1300 for implementing improved acknowledgment and re-transmission protocols for wireless communication according to aspects of the subject disclosure. For instance, systems 1200, 1300 can reside at least partially within a wireless communication network and/or within a wireless receiver such as a node, base station, access point, user terminal, personal computer coupled with a mobile interface card, or the like. It is to be appreciated that systems 1200, 1300 are represented as including functional blocks, which can be functional blocks that represent functions implemented by a processor, software, or combination thereof (e.g., firmware).

System 1200 can comprise memory 1202 for storing or interfacing with modules configured to execute functions of system 1200, including network arbitration based on performance or quality characteristics of respective networks. System 1200 can additionally comprise a module 1204 for employing a network gateway for establishing an electronic communication session for an AT over a RAN. Establishing the electronic communication session can comprise, for instance, creating a context for the AT with the first RAN, and associated bindings for the electronic communication session (e.g., IP bindings, TCP/IP bindings, or the like). System 1200 can also comprise a module 1206 for employing a processor 1210 for analyzing wireless communication invites involving the AT. Moreover, system 1200 can comprise a module 1308 for employing the network gateway to conduct call-specific signaling for the AT over the first RAN to facilitate a wireless communication on a second RAN that is not supported by the first RAN.

System 1300 can comprise memory 1302 for storing or interfacing with modules configured to execute functions of system 1300, including facilitating network arbitration based on network capabilities and data session requirements. Particularly, system 1300 can comprise a module 1304 for employing a wireless transceiver to receive wireless signals from a plurality of RANs. Additionally, system 1300 can comprise a module 1306 for employing a data processor 1310 to analyze characteristics of the wireless signals and select a preferred RAN from the plurality of RANs (e.g., based on highest throughput, highest data rate, or other suitable characteristic for supporting a call initiated over the preferred RAN). Further, system 1300 can comprise a module 1308 for employing the wireless transceiver to initiate or receive a an application or session over the preferred RAN, and activate a link with a second RAN of the plurality of RANs that supports the application or session (e.g., if the preferred RAN does not support, or provide an equivalent subscription charging rate, the application or session).

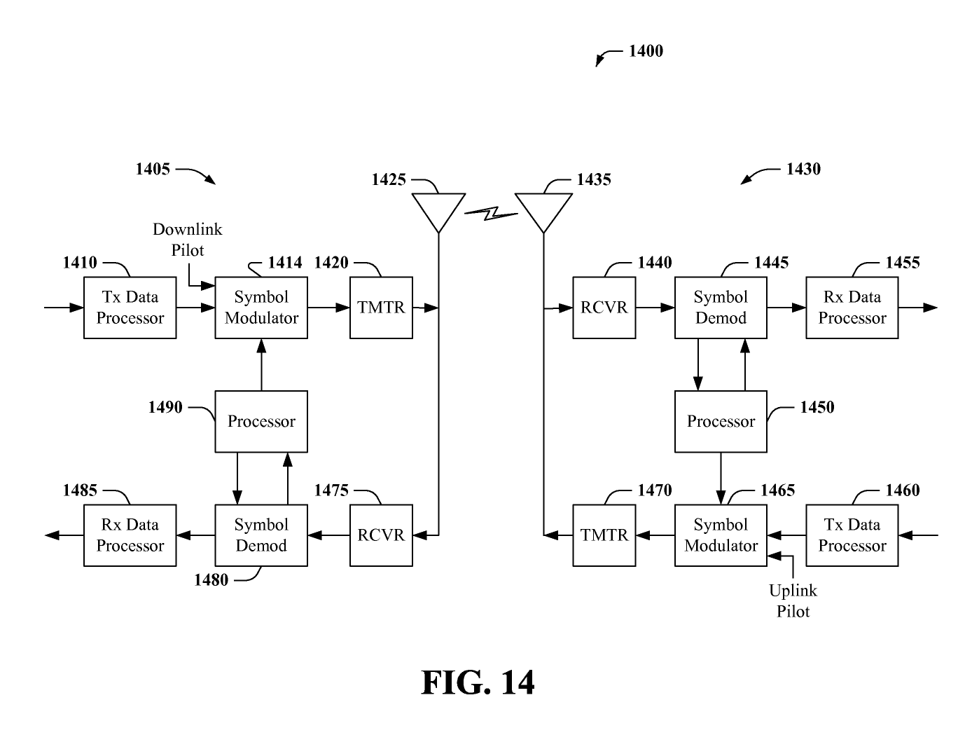

FIG. 14 depicts a block diagram of an example system 1400 that can facilitate wireless communication according to some aspects disclosed herein. On a downlink, at access point 1405, a transmit (TX) data processor 1410 receives, formats, codes, interleaves, and modulates (or symbol maps) traffic data and provides modulation symbols (“data symbols”). A symbol modulator 1414 receives and processes the data symbols and pilot symbols and provides a stream of symbols. A symbol modulator 1414 multiplexes data and pilot symbols and provides them to a transmitter unit (TMTR) 1420. Each transmit symbol can be a data symbol, a pilot symbol, or a signal value of zero. The pilot symbols can be sent continuously in each symbol period. The pilot symbols can be frequency division multiplexed (FDM), orthogonal frequency division multiplexed (OFDM), time division multiplexed (TDM), code division multiplexed (CDM), or a suitable combination thereof or of like modulation and/or transmission techniques.

TMTR 1420 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through an antenna 1425 to the terminals. At terminal 1430, an antenna 1435 receives the downlink signal and provides a received signal to a receiver unit (RCVR) 1440. Receiver unit 1440 conditions (e.g., filters, amplifies, and frequency downconverts) the received signal and digitizes the conditioned signal to obtain samples. A symbol demodulator 1445 demodulates and provides received pilot symbols to a processor 1450 for channel estimation. Symbol demodulator 1445 further receives a frequency response estimate for the downlink from processor 1450, performs data demodulation on the received data symbols to obtain data symbol estimates (which are estimates of the transmitted data symbols), and provides the data symbol estimates to an RX data processor 1455, which demodulates (i.e., symbol demaps), deinterleaves, and decodes the data symbol estimates to recover the transmitted traffic data. The processing by symbol demodulator 1445 and RX data processor 1455 is complementary to the processing by symbol modulator 1414 and TX data processor 1410, respectively, at access point 1405.

On the uplink, a TX data processor 1460 processes traffic data and provides data symbols. A symbol modulator 1465 receives and multiplexes the data symbols with pilot symbols, performs modulation, and provides a stream of symbols. A transmitter unit 1470 then receives and processes the stream of symbols to generate an uplink signal, which is transmitted by the antenna 1435 to the access point 1405. Specifically, the uplink signal can be in accordance with SC-FDMA requirements and can include frequency hopping mechanisms as described herein.

At access point 1405, the uplink signal from terminal 1430 is received by the antenna 1425 and processed by a receiver unit 1475 to obtain samples. A symbol demodulator 1480 then processes the samples and provides received pilot symbols and data symbol estimates for the uplink. An RX data processor 1485 processes the data symbol estimates to recover the traffic data transmitted by terminal 1430. A processor 1490 performs channel estimation for each active terminal transmitting on the uplink. Multiple terminals can transmit pilot concurrently on the uplink on their respective assigned sets of pilot sub-bands, where the pilot sub-band sets can be interlaced.

Processors 1490 and 1450 direct (e.g., control, coordinate, manage, etc.) operation at access point 1405 and terminal 1430, respectively. Respective processors 1490 and 1450 can be associated with memory units (not shown) that store program codes and data. Processors 1490 and 1450 can also perform computations to derive frequency and time-based impulse response estimates for the uplink and downlink, respectively.

For a multiple-access system (e.g., SC-FDMA, FDMA, OFDMA, CDMA, TDMA, etc.), multiple terminals can transmit concurrently on the uplink. For such a system, the pilot sub-bands can be shared among different terminals. The channel estimation techniques can be used in cases where the pilot sub-bands for each terminal span the entire operating band (possibly except for the band edges). Such a pilot sub-band structure would be desirable to obtain frequency diversity for each terminal. The techniques described herein can be implemented by various means. For example, these techniques can be implemented in hardware, software, or a combination thereof. For a hardware implementation, which can be digital, analog, or both digital and analog, the processing units used for channel estimation can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes can be stored in memory unit and executed by the processors 1490 and 1450.

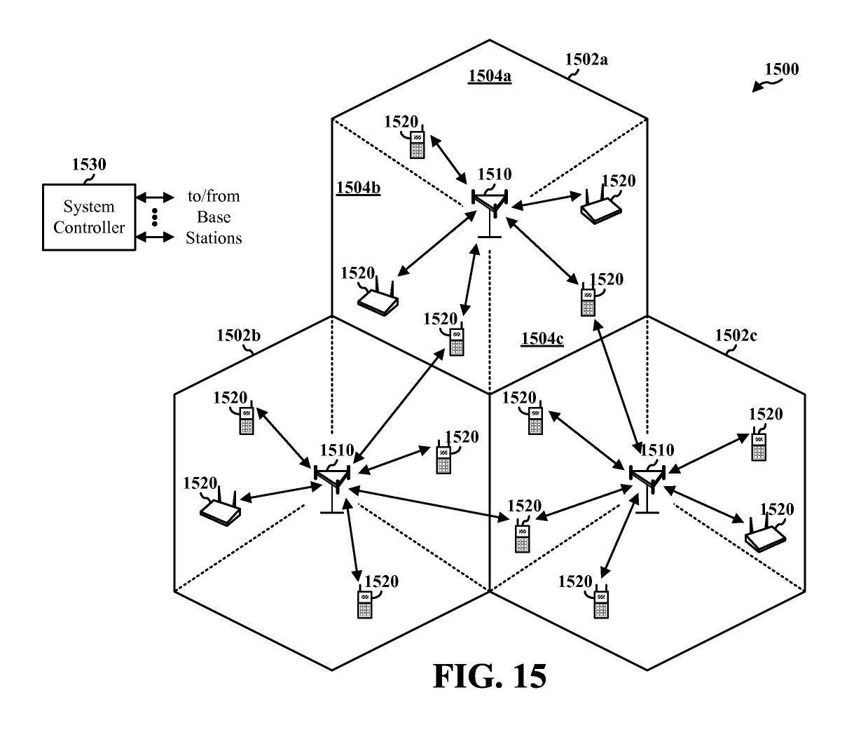

FIG. 15 illustrates a wireless communication system 1500 with multiple base stations (BSs) 1510 (e.g., wireless access points, wireless communication apparatus) and multiple terminals 1520 (e.g., ATs), such as can be utilized in conjunction with one or more aspects. ABS 1510 is generally a fixed station that communicates with the terminals and can also be called an access point, a Node B, or some other terminology. Each BS 1510 provides communication coverage for a particular geographic area or coverage area, illustrated as three geographic areas in FIG. 15, labeled 1502a, 1502b, and 1502c. The term “cell” can refer to a BS or its coverage area depending on the context in which the term is used. To improve system capacity, a BS geographic area/coverage area can be partitioned into multiple smaller areas (e.g., three smaller areas, according to cell 1502a in FIG. 15), 1504a, 1504b, and 1504c. Each smaller area (1504a, 1504b, 1504c) can be served by a respective base transceiver subsystem (BTS). The term “sector” can refer to a BTS or its coverage area depending on the context in which the term is used. For a sectorized cell, the BTSs for all sectors of that cell are typically co-located within the base station for the cell. The transmission techniques described herein can be used for a system with sectorized cells as well as a system with un-sectorized cells. For simplicity, in the subject description, unless specified otherwise, the term “base station” is used generically for a fixed station that serves a sector as well as a fixed station that serves a cell.

Terminals 1520 are typically dispersed throughout the system, and each terminal 1520 can be fixed or mobile. Terminals 1520 can also be called a mobile station, user equipment, a user device, wireless communication apparatus, an access terminal, a user terminal or some other terminology. A terminal 1520 can be a wireless device, a cellular phone, a personal digital assistant (PDA), a wireless modem card, and so on. Each terminal 1520 can communicate with zero, one, or multiple BSs 1510 on the downlink (e.g., FL) and uplink (e.g., RL) at any given moment. The downlink refers to the communication link from the base stations to the terminals, and the uplink refers to the communication link from the terminals to the base stations.

For a centralized architecture, a system controller 1530 couples to base stations 1510 and provides coordination and control for BSs 1510. For a distributed architecture, BSs 1510 can communicate with one another as needed (e.g., by way of a wired or wireless backhaul network communicatively coupling the BSs 1510). Data transmission on the forward link often occurs from one access point to one access terminal at or near the maximum data rate that can be supported by the forward link or the communication system. Additional channels of the forward link (e.g., control channel) can be transmitted from multiple access points to one access terminal. Reverse link data communication can occur from one access terminal to one or more access points.

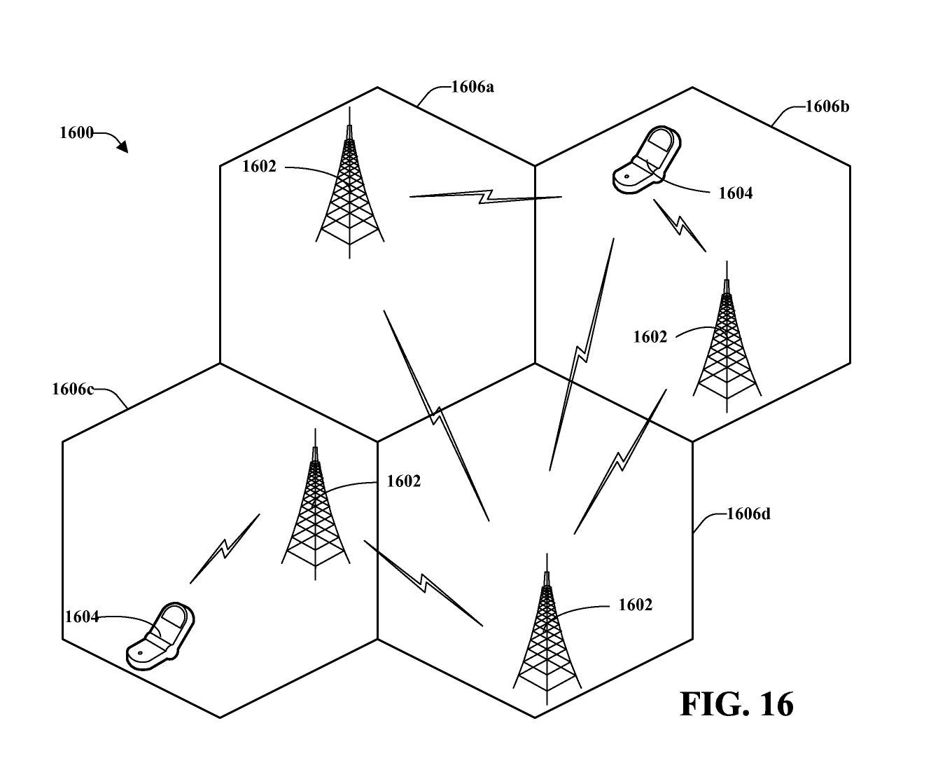

FIG. 16 is an illustration of a planned or semi-planned wireless communication environment 1600, in accordance with various aspects. Wireless communication environment 1600 can comprise one or more BSs 1602 in one or more cells and/or sectors that receive, transmit, repeat, etc., wireless communication signals to each other and/or to one or more mobile devices 1604. As illustrated, each BS 1602 can provide communication coverage for a particular geographic area, illustrated as four geographic areas, labeled 1606a, 1606b, 1606c and 1606d. Each BS 1602 can comprise a transmitter chain and a receiver chain, each of which can in turn comprise a plurality of components associated with signal transmission and reception (e.g., processors, modulators, multiplexers, demodulators, demultiplexers, antennas, and so forth, see FIG. 15, supra), as will be appreciated by one skilled in the art. Mobile devices 1604 can be, for example, cellular phones, smart phones, laptops, handheld communication devices, handheld computing devices, satellite radios, global positioning systems, PDAs, or any other suitable device for communicating over wireless communication environment 1600. Wireless communication environment 1600 can be employed in conjunction with various aspects described herein in order to facilitate arbitration among wireless RANs in wireless communications, as set forth herein.

As used in the subject disclosure, the terms “component,” “system,” “module” and the like are intended to refer to a computer-related entity, either hardware, software, software in execution, firmware, middle ware, microcode, and/or any combination thereof. For example, a module can be, but is not limited to being, a process running on a processor, a processor, an object, an executable, a thread of execution, a program, a device, and/or a computer. One or more modules can reside within a process, or thread of execution; and a module can be localized on one electronic device, or distributed between two or more electronic devices. Further, these modules can execute from various computer-readable media having various data structures stored thereon. The modules can communicate by way of local or remote processes such as in accordance with a signal having one or more data packets (e.g., data from one component interacting with another component in a local system, distributed system, or across a network such as the Internet with other systems by way of the signal). Additionally, components or modules of systems described herein can be rearranged, or complemented by additional components/modules/systems in order to facilitate achieving the various aspects, goals, advantages, etc., described with regard thereto, and are not limited to the precise configurations set forth in a given figure, as will be appreciated by one skilled in the art.

Furthermore, various aspects are described herein in connection with a UE. A UE can also be called a system, a subscriber unit, a subscriber station, mobile station, mobile, mobile communication device, mobile device, remote station, remote terminal, access terminal (AT), user agent (UA), a user device, or user terminal (UE). A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device.

In one or more exemplary embodiments, the functions described can be implemented in hardware, software, firmware, middleware, microcode, or any suitable combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media may be any physical media that can be accessed by a computer. By way of example, and not limitation, such computer storage media can comprise RAM, ROM, EEPROM, CD-ROM or other optical disk storage, magnetic disk storage or other magnetic storage devices, smart cards, and flash memory devices (e.g., card, stick, key drive . . . ), or any other medium that can be used to carry or store desired program code in the form of instructions or data structures and that can be accessed by a computer. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

For a hardware implementation, the processing units' various illustrative logics, logical blocks, modules, and circuits described in connection with the aspects disclosed herein can be implemented or performed within one or more ASICs, DSPs, DSPDs, PLDs, FPGAs, discrete gate or transistor logic, discrete hardware components, general purpose processors, controllers, micro-controllers, microprocessors, other electronic units designed to perform the functions described herein, or a combination thereof. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other suitable configuration. Additionally, at least one processor can comprise one or more modules operable to perform one or more of the steps and/or actions described herein.

Moreover, various aspects or features described herein can be implemented as a method, apparatus, or article of manufacture using standard programming and/or engineering techniques. Further, the steps and/or actions of a method or algorithm described in connection with the aspects disclosed herein can be embodied directly in hardware, in a software module executed by a processor, or in a combination of the two. Additionally, in some aspects, the steps or actions of a method or algorithm can reside as at least one or any combination or set of codes or instructions on a machine-readable medium, or computer-readable medium, which can be incorporated into a computer program product. The term “article of manufacture” as used herein is intended to encompass a computer program accessible from any suitable computer-readable device or media.

Additionally, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, as used herein, the terms to “infer” or “inference” refer generally to the process of reasoning about or inferring states of the system, environment, or user from a set of observations as captured via events, or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events, or data. Such inference results in the construction of new events or actions from a set of observed events and/or stored event data, whether or not the events are correlated in close temporal proximity, and whether the events and data come from one or several event and data sources.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A method of wireless communication, comprising:
instructing a wireless core network gateway to provide wireless communication service to a mobile device via a first radio access network (a first RAN); and
instructing the wireless core network gateway to establish session or application specific signaling at least in part over the first RAN for a wireless communication to be conducted over a second RAN.

2. The method of claim 1, further comprising at least one of:
maintaining the wireless communication service on the first RAN while an application or wireless session associated with the session or application specific signaling is conducted on the second RAN; or
transferring a wireless communication associated with the wireless communication service on the first RAN to the second RAN following a handover of the mobile device to the second RAN.

3. The method of claim 2, wherein maintaining the wireless communication service on the first RAN further comprises routing traffic of the wireless communication service to the second RAN via a communication link between the first RAN and the second RAN.

4. The method of claim 2, wherein maintaining the wireless communication service on the first RAN further comprises employing the wireless core network gateway to establish a packet context for the mobile device on the second RAN and routing traffic from the wireless core network gateway to a gateway of the second RAN.

5. The method of claim 1, further comprising establishing an application or wireless session associated with the session or application specific signaling directly to the second RAN, and terminating a context for the application or wireless session on the second RAN or switching the context to the first RAN when the application or wireless session is terminated.

6. The method of claim 1, further comprising sending a channel assignment for the second RAN to the mobile device via a communication link between the first RAN and the second RAN.

7. The method of claim 1, wherein the session or application specific signaling pertains to a specific QoS call, or a low or fixed cost call, and further wherein the first RAN does not support the specific QoS call, or the low or fixed cost call.

8. The method of claim 1, further comprising initiating or effecting a handover of the mobile device from the first RAN to the second RAN in conjunction with establishing an application or wireless session associated with the session or application specific signaling.

9. The method of claim 1, further comprising employing a network processing entity to identify an application or wireless session associated with the session or application specific signaling that is initiated by or that targets the mobile device.

10. The method of claim 9, further comprising sending a paging message to the mobile device via the second RAN and a connection between the second RAN and the first RAN if the application or wireless session targets the mobile device.

11. The method of claim 9, further comprising receiving an invitation for the application or wireless session from the mobile device via the first RAN or the second RAN if the invitation is initiated by the mobile device.

12. An apparatus configured for wireless communication, comprising:
a communication interface that facilitates electronic communication with a first radio access network (a first RAN) and with a second RAN;
memory for storing instructions configured to provide call-specific signaling for the second RAN over the first RAN; and
a data processor configured to execute modules that implement the call-specific signaling, the modules comprising:
a context module that establishes an electronic communication session for an access terminal (AT) over the first RAN;
an arbitration module that analyzes call invitations involving the AT; and
a switching module that causes the context module to establish, at least in part via the first RAN, a second communication session for the AT on the second RAN for a wireless communication involving the AT that is not supported by the first RAN.

13. The apparatus of claim 12, wherein the first RAN comprises a third generation partnership project (3GPP) long term evolution (LTE) evolved universal terrestrial radio access network (eUTRAN).

14. The apparatus of claim 12, wherein the first RAN comprises a WiFi access network, or a worldwide interoperability for microwave access (WiMAX) access network.

15. The apparatus of claim 12, wherein the second RAN comprises a high speed packet access (HSPA) access network.

16. The apparatus of claim 12, wherein the wireless communication comprises a voice over internet protocol call (a VoIP call), and further wherein the first RAN does not support a level of QoS sufficient to handle the VoIP call, and the second RAN does support the level of QoS.

17. The apparatus of claim 12, wherein the context module maintains the electronic communication session over the first RAN while the second communication session over the second RAN exists.

18. The apparatus of claim 12, further comprising a paging module that forwards an application-level signaling invitation pertaining to the wireless communication to the AT if the arbitration module identifies a call invitation involving the AT that is not supported by the first RAN.

19. The apparatus of claim 18, wherein the application-level signaling invitation is routed at least one of:
directly over the first RAN to the AT; or
through the second RAN over a link that communicatively couples the first RAN to the second RAN, to a base station or switching center of the first RAN that serves the AT.

20. The apparatus of claim 12, further comprising a handover module that instructs the AT to execute a handover to the second RAN when the arbitration module identifies the wireless communication that is not supported by the first RAN, or upon completion of setup for the wireless communication.

21. The apparatus of claim 12, wherein the AT responds to an invitation for the wireless communication prior to conducting a handover to the second RAN, and further wherein the context module completes setup of the wireless communication prior to establishing the second communication session on the second RAN.

22. The apparatus of claim 12, wherein the AT conducts a handover to the second RAN prior to responding to an invitation for the wireless communication, and further wherein the context module establishes the second communication session prior to completing setup of the wireless communication.

23. An apparatus of wireless communication, comprising:
means for employing a network gateway for establishing an electronic communication session for an access terminal (AT) over a first radio access network (a first RAN);
means for employing a processor for analyzing wireless communication invites involving the AT; and
means for employing the network gateway to conduct call-specific signaling for the AT over the first RAN to facilitate a wireless communication on a second radio access network that is not supported by the first RAN.

24. At least one processor configured for wireless communication, comprising:
a module that establishes an electronic communication session for an access terminal (AT) over a first radio access network (a first RAN);
a module that analyzes wireless communication invites involving the AT; and
a module that conducts call-specific signaling for the AT over the first RAN to facilitate a wireless communication on a second radio access network that is not supported by the first RAN.

25. A computer program product, comprising:
a computer-readable medium, comprising:
code for causing a computer to establish an electronic communication session for an access terminal (AT) over a first radio access network (a first RAN);
code for causing the computer to analyze wireless communication invites involving the AT; and
code for causing the computer to conduct call-specific signaling for the AT over the first RAN to facilitate a wireless communication on a second radio access network that is not supported by the first RAN.

26. A method of wireless communication, comprising:
employing a wireless transceiver to receive wireless signals from a plurality of radio access networks (a plurality of RANs);
employing a data processor to analyze characteristics of the wireless signals and select a preferred radio access network (a preferred RAN) from the plurality of RANs; and
employing the wireless transceiver to initiate or receive an application or session over the preferred RAN, and to activate a link with a second RAN of the plurality of RANs that supports the application or session.

27. The method of claim 26, further comprising receiving an invite for the application or session from a serving base station of the preferred RAN.

28. The method of claim 27, further comprising first responding to the application or session over the preferred RAN and then performing a handover to a base station of the second RAN to conduct the application or session.

29. The method of claim 27, further comprising first performing a handover to a base station of the second RAN and then responding to the application or session over the second RAN.

30. The method of claim 26, further comprising maintaining the application or session over the second RAN concurrently with a data session established over the preferred RAN.

31. The method of claim 26, further comprising porting a data session established over the preferred RAN to the second RAN upon activating the link with the second RAN.

32. The method of claim 26, further comprising first terminating a data session established with the preferred RAN prior to establishing the link with the second RAN for the application or session.

33. The method of claim 26, further comprising establishing the link and performing an Internet Protocol mobility service registration (an IMS registration) with the second RAN upon selecting the preferred RAN, and maintaining the link with the second RAN as inactive until receiving indication that the preferred RAN lacks QoS capabilities to support the application or session.

34. The method of claim 33, further comprising at least one of:
deactivating a first link with the preferred RAN upon activating the link with the second RAN; or
activating the link with the second RAN upon receiving a command from the preferred RAN to conduct a handover to the second RAN, or upon receiving a page from the second RAN routed over the first link.

35. The method of claim 33, further comprising conducting IMS signaling associated with the IMS registration and IMS signaling associated with setup of the application or session over the preferred RAN, or over the second RAN.

36. The method of claim 33, wherein the application or session comprises a high QoS call, or a low cost or fixed cost call.

37. An apparatus for wireless communication, comprising:
a communication interface that is configured to employ a wireless transceiver to communicatively couple the apparatus with a plurality of radio access networks (a plurality of RANs);
memory for storing instructions configured for selecting different ones of the plurality of RANs based at least on attributes of a wireless communication; and
a data processor that executes modules to implement the instructions, the modules comprising:
a network statistics module that references characteristics of one or more of the plurality of RANs based at least on attributes of an anticipated wireless session;
a swapping module that dynamically switches from a preferred RAN having a first set of capabilities to a second RAN having a second set of capabilities, if a wireless session is initiated at or received by the apparatus, and if the second set of capabilities provide preferable service or cost for the wireless session over the first set of capabilities.

38. The apparatus of claim 37, further comprising a traffic module that transitions network bindings established for an existing data session among one or more of the plurality of RANs.

39. The apparatus of claim 38, wherein the traffic module transitions the network bindings from the preferred RAN to the second RAN upon initiation or receipt of the wireless session.

40. The apparatus of claim 38, wherein the traffic module maintains the network bindings on the preferred RAN while the wireless session is conducted on the second RAN.

41. The apparatus of claim 37, further comprising a calling module that initiates the wireless session for the apparatus.

42. The apparatus of claim 41, wherein the calling module forwards a quality of service (QoS) or subscription attribute of the wireless session to the network statistics module and obtains respective sets of capabilities for a subset of the plurality of RANs.

43. The apparatus of claim 42, wherein the calling module instructs the swapping module to switch from the preferred RAN to the second RAN if the QoS or subscription attribute of the wireless session is not supported by the preferred RAN, and further wherein the calling module initiates the wireless session once the apparatus is connected to the second RAN.

44. The apparatus of claim 37, further comprising a receiver module that obtains and analyzes session invites sent to the apparatus from the preferred RAN.

45. The apparatus of claim 44, wherein the receiver module obtains a QoS or subscription capability of the preferred RAN from the network statistics module upon analyzing a session invite for the wireless session.

46. The apparatus of claim 45, wherein the receiver module compares a QoS or subscription attribute of the wireless session to the QoS or subscription capability and instructs the swapping module to dynamically switch from the preferred RAN to the second RAN if the QoS or subscription capability does support the QoS or subscription attribute.

47. The apparatus of claim 37, wherein the swapping module dynamically switches to the preferred RAN upon termination of the wireless session.

48. An apparatus for wireless communication, comprising:
means for employing a wireless transceiver to receive wireless signals from a plurality of radio access networks (a plurality of RANs);
means for employing a data processor to analyze characteristics of the wireless signals and select a preferred radio access network (a preferred RAN) from the plurality of RANs; and
means for employing the wireless transceiver to initiate or receive an application or session over the preferred RAN, and activate a link with a second RAN of the plurality of RANs that supports the application or session.

49. At least one processor configured for wireless communication, comprising:
a module that receives wireless signals from a plurality of radio access networks (a plurality of RANs);
a module that analyzes characteristics of the wireless signals and selects a preferred radio access network (a preferred RAN) from the plurality of RANs; and
a module that initiates or receives an application or session over the preferred RAN, and activates a link with a second RAN of the plurality of RANs that supports the application or session.

50. A computer program product, comprising:
a computer-readable medium, comprising:
code for causing a computer to receive wireless signals from a plurality of radio access networks (a plurality of RANs);
code for causing the computer to analyze characteristics of the wireless signals and select a preferred radio access network (a preferred RAN) from the plurality of RANs having highest signal performance; and
code for causing the computer to initiate or receive an application or session over the preferred RAN, and activate a link with a second RAN of the plurality of RANs that supports the application or session.
